(19) United States
(12) Patent Application Publication
(10) Pub. No.: US 2017/0235288 A1
(43) Pub. Date: Aug. 17, 2017

(54) PROCESS CONTROL PROGRAM, PROCESS CONTROL DEVICE, AND PROCESS CONTROL METHOD

(71) Applicant: FUJITSU LIMITED, Kawasaki-shi (JP)

(72) Inventors: Hisashi Tsujide, Takarazuka (JP); Kiyoshi KOUGE, Kuwana (JP); SHOTARO OKADA, Nishinomiya (JP); Toru Kitayama, Kobe (JP); Toshitsugu Mori, Akashi (JP); TAKASHI IKEZAKI, Yatomi (JP)

(73) Assignee: FUJITSU LIMITED, Kawasaki-shi (JP)

(21) Appl. No.: 15/416,807

(22) Filed: Jan. 26, 2017

(30) Foreign Application Priority Data
Feb. 12, 2016 (JP) 2016-024560

(51) Int. Cl. G05B 19/042

(52) U.S. Cl. CPC G05B 19/0426; G05B 2219/25274

(57) ABSTRACT

A non-transitory computer-readable storage medium storing therein a process control program that causes a computer to execute a process includes: receiving a connection start instruction from a process request device that transmits a process request to the computer; and determining, in a case where a plurality of connection start instructions to be processed are present, a first connection start instruction that is preferentially processed from among the plurality of connection start instructions based on an allocation amount of a resource to each of a plurality of information processing systems corresponding to each of the plurality of connection start instructions and a usage amount of the resource in each of the plurality of information processing systems.

### CROSS-REFERENCE TO RELATED APPLICATION

This application is based upon and claims the benefit of priority of the prior Japanese Patent Application No. 2016-024560, filed on Feb. 12, 2016, the entire contents of which are incorporated herein by reference.

### FIELD

The present invention relates to a process control program, a process control device, and a process control method.

### BACKGROUND

A business operator that provides a service to a user (hereinafter also referred to as a service provider simply) configures and operates, e.g., a business system suitable for a use (hereinafter also referred to as an information processing system) in order to provide various services to the user. In this case, the service provider rents a public cloud environment including a resource needed for configuring the business system from, e.g., a business operator that rents the public cloud environment (hereinafter also referred to as a cloud service provider). Subsequently, the service provider configures the business system in the rented public cloud environment to thereby provide the service to the user.

In general, the cloud service provider described above provides a management device for managing the public cloud environment to be rented to the service provider. The management device performs, e.g., monitoring of the status of use of the resource of each physical machine that constitutes the public cloud environment. In addition, for example, the cloud service provider refers to information acquired by the management device to perform addition of the physical machine that constitutes the public cloud environment and suspension of part of the physical machines. With this, it becomes possible for the cloud service provider to efficiently operate the physical machine that constitutes the public cloud environment (see, e.g., Japanese Laid-open Patent Publication No. 2007-102666, Japanese Laid-open Patent Publication No. 2003-281015, Japanese Laid-open Patent Publication No. H11-163947, Japanese Laid-open Patent Publication No. H6-309156, and Japanese Laid-open Patent Publication No. 2013-69260).

### SUMMARY

According to an aspect of the embodiments A non-transitory computer-readable storage medium storing therein a process control program that causes a computer to execute a process includes: receiving a connection start instruction from a process request device that transmits a process request to the computer; and determining, in a case where a plurality of connection start instructions to be processed are present, a first connection start instruction that is preferentially processed from among the plurality of connection start instructions based on an allocation amount of a resource to each of a plurality of information processing systems corresponding to each of the plurality of connection start instructions and a usage amount of the resource in each of the plurality of information processing systems.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating the configuration of a management device 1 and a physical machine 2.

FIG. 2 is views for explaining the specific example when the large-scale public cloud environment is managed.

FIG. 3 is views for explaining the specific example when the large-scale public cloud environment is managed.

FIG. 4 is a view for explaining the physical machine 2 in the first embodiment.

FIG. 5 is a view illustrating the hardware configurations of the management device 1 and the physical machine 2.

FIG. 6 is a functional block diagram of the management device 1.

FIG. 7 is a functional block diagram of the physical machine 2.

FIG. 8 is flowcharts for explaining the outline of the process control process in the first embodiment.

FIG. 9 is flowcharts for explaining the outline of the process control process in the first embodiment.

FIG. 10 is views for explaining the outline of the process control process in the first embodiment.

FIG. 11 is views for explaining the outline of the process control process in the first embodiment.

FIG. 12 is views for explaining the outline of the process control process in the first embodiment.

FIG. 13 is views for explaining the outline of the process control process in the first embodiment.

FIG. 14 is flowcharts for explaining the detail of the process control process in the first embodiment.

FIG. 15 is flowcharts for explaining the detail of the process control process in the first embodiment.

FIG. 16 is flowcharts for explaining the detail of the process control process in the first embodiment.

FIG. 17 is flowcharts for explaining the detail of the process control process in the first embodiment.

FIG. 18 is flowcharts for explaining the detail of the process control process in the first embodiment.

FIG. 19 is flowcharts for explaining the detail of the process control process in the first embodiment.

FIG. 20 is a view for explaining the specific example of the operation execution information 131.

FIG. 21 is a view for explaining the specific example of the connection information 132.

FIG. 22 is a view for explaining the specific example of the allocation amount information 133.

FIG. 23 is views for explaining the specific example of the connection start instruction transmitted by the management device 1.

FIG. 24 is views for explaining the specific example of the connection start instruction information 233 stored in the information storage area 230.

FIG. 25 is views for explaining the specific example of the connection start instruction transmitted by the management device 1.

FIG. 26 is views for explaining the specific example of the connection start instruction information 233 stored in the information storage area 230.

FIG. 27 is views for explaining the specific example of the execution instruction of the first process.

FIG. 28 is views for explaining the specific example of the execution instruction of the first process.

FIG. 29 is views for explaining the specific example of the process result information 234.

FIG. 30 is views for explaining the specific example of the process result information 234.

### DESCRIPTION OF EMBODIMENTS

In the case where the number of the physical machines that constitute the public cloud environment is increased in the public cloud environment described above, the cloud service provider performs the management of the individual physical machines by, e.g., providing a plurality of management devices.

However, in the case where the number of the management devices to be provided for managing the individual physical machines is increased, the cost needed for maintenance of the public cloud environment is increased. Accordingly, it is preferable for the cloud service provider to perform the management of all of the physical machines that constitute the public cloud environment with as few management devices as possible. The first embodiment will be explained hereinbelow.

[Configuration of Management Device and Physical Machine]

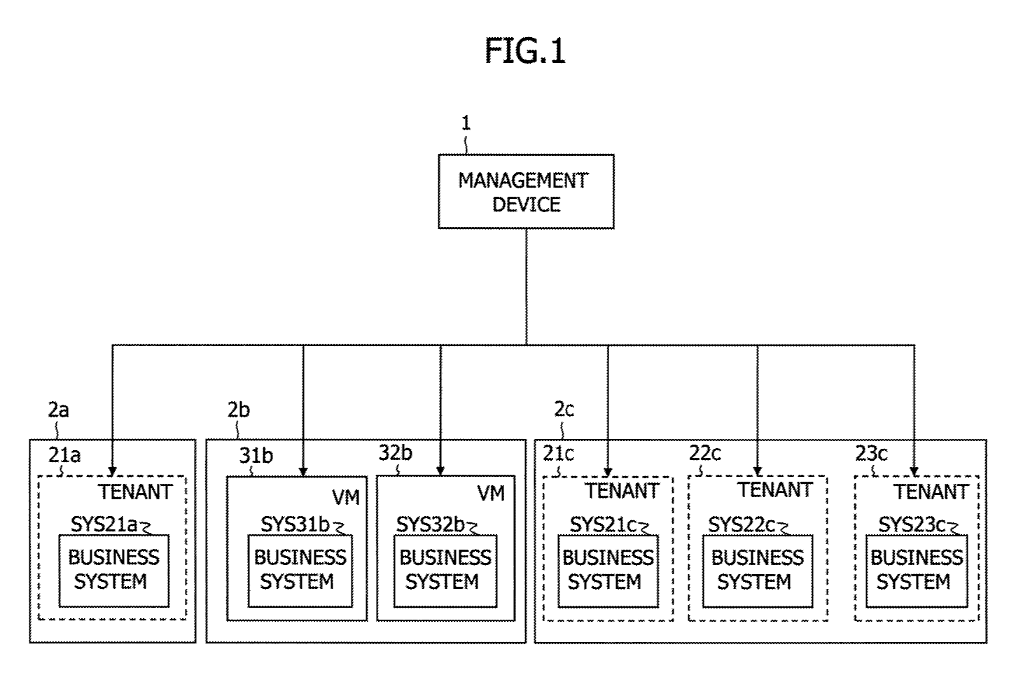

FIG. 1 is a view illustrating the configuration of a management device 1 and a physical machine 2. In an example illustrated in FIG. 1, the management device 1 (hereinafter also referred to as a process request device 1), a physical machine 2a, a physical machine 2b, and a physical machine 2c are provided in, e.g., a data center that is not illustrated. Hereinafter, the physical machine 2a, the physical machine 2b, and the physical machine 2c are also collectively referred to as physical machines 2, process devices 2 or process control devices 2. Hereinafter, the case where one management device 1 is connected with three physical machines (the physical machines 2a, 2b, and 2c) will be described, but the management device 1 may be connected with the physical machines 2 of which the number is other than the above number.

The physical machines 2 are physical machines that constitute a public cloud environment. A cloud service provider divides resources of each physical machine 2 into logical units (hereinafter also referred to as tenants) that are rented to a service provider, and manages them.

Specifically, in the example illustrated in FIG. 1, the physical machine 2a has a tenant 21a. In addition, the physical machine 2c has a tenant 21c, a tenant 22c, and a tenant 23c. In the tenants 21a, 21c, 22c, and 23c, business systems SYS21a, SYS21c, SYS22c, and SYS23c (a business system operated by the service provider for providing a service to a user) are configured respectively. Note that the cloud service provider may rent, e.g., the individual tenants to different service providers. In addition, the cloud service provider may rent, e.g., a plurality of tenants to the same service provider.

On the other hand, in the example illustrated in FIG. 1, in the physical machine 2b, a virtual machine 31b and a virtual machine 32b operate. Hereinafter, the virtual machine (VM) 31b and the virtual machine (VM) 32b are also collectively referred to as virtual machines 3.

Specifically, for example, virtualization software (software (not illustrated) that operates in the physical machine 2b or the like) instructed by the management device 1 allocates resources of the physical machine 2b, and the virtual machine 31b and the virtual machine 32b are thereby generated.

In addition, in the example illustrated in FIG. 1, in the virtual machine 31b and the virtual machine 32b, a business system SYS31b and a business system SYS32b (the business system operated by the service provider for providing the service to the user) are configured respectively. Note that, similarly to the case of the physical machines 2, the cloud service provider may divide the resources of the individual virtual machines 3 into a plurality of tenants and manage them.

The management device 1 monitors, e.g., the status of use of the resource of each physical machine 2 or the like at a predetermined timing. In the case where the management device 1 detects, e.g., that the resource of the physical machine 2 is insufficient, the management device 1 notifies the cloud service provider of the insufficiency of the resource.

Note that, hereinafter, the tenant and the virtual machine 3 rented to the service provider by the cloud service provider are collectively referred to the tenant simply. In addition, hereinafter, it is assumed that only one business system can be configured in each tenant. Further, hereinafter, it is assumed that the service provider that rents the tenant can determine (change) the allocation amount of the resource to the rented tenant by performing setting of the management device 1 or the like.

[Specific Example when Large-Scale Public Cloud Environment is Managed]

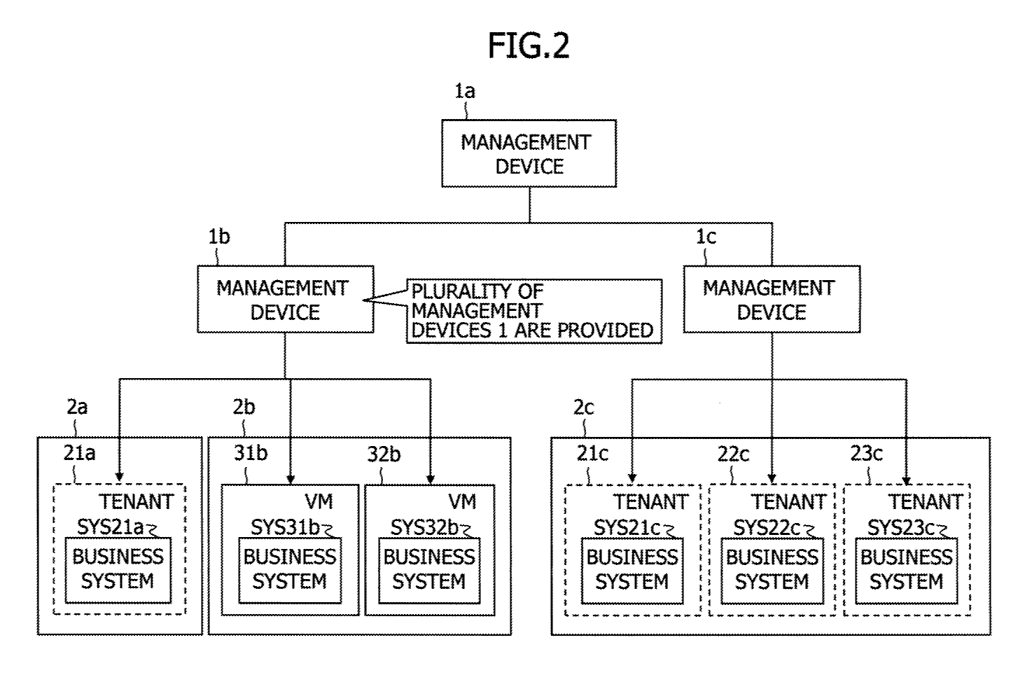

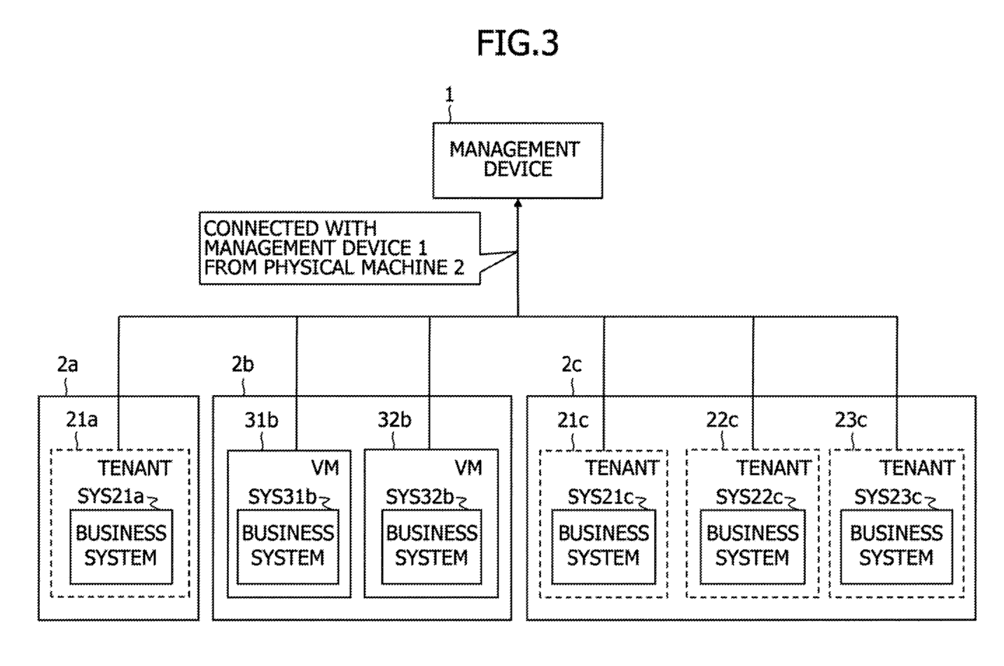

Next, a description will be given of a specific example when a large-scale public cloud environment is managed. FIGS. 2 and 3 are views for explaining the specific example when the large-scale public cloud environment is managed.

When the number of the physical machines 2 that constitute the public cloud environment is increased in the public cloud environment explained in FIG. 1, there are cases where the cloud service provider needs to additionally provide the management device 1.

Specifically, in the case where the management device 1 performs the setting of a connection (a connection by a transmission control protocol (TCP)) to each physical machine 2, the management device 1 uses ephemeral ports. Accordingly, in the case where the number of the physical machines 2 that are connected at the same time by the management device 1 has reached the upper limit number (16,383) of the ephemeral ports of the management device 1, the management device 1 is not able to set a new connection with the physical machine 2. Consequently, in this case, the management device 1 is not able to perform the management of all of the physical machines 2 that constitute the public cloud environment.

To cope with this, in the case where the number of the physical machines 2 that constitute the public cloud environment is increased, as illustrated in FIG. 2, the cloud service provider additionally provides the management device 1. With this, even in the case where the number of the physical machines 2 that constitute the public cloud environment is increased, it becomes possible for the cloud service provider to manage all of the physical machines 2.

However, in the case where the number of the management devices 1 provided for managing the individual physical machines 2 is increased, the cost needed for the maintenance of the public cloud environment is increased. Accordingly, it is preferable for the cloud service provider to perform the management of all of the physical machines 2 that constitute the public cloud environment with as few management devices 1 as possible.

To cope with this, for example, as illustrated in FIG. 3, there are cases where the cloud service provider causes the physical machine 2 to perform the setting of the connection between the management device 1 and the physical machine 2. With this, it becomes possible for the management device 1 to perform the setting of the connection with the physical machine 2 without using a large number of the ephemeral ports of the management device 1.

However, the connection set between the management device 1 and the physical machine 2 is handled as a descriptor in the operating system (OS) of the management device 1. Accordingly, even in the case where the number of the connections set by the management device 1 does not reach the upper limit number of the ephemeral ports, when the descriptor reaches the upper limit, the management device 1 is not able to perform the setting of the new connection with the physical machine 2.

Accordingly, the physical machine 2 in the present embodiment receives a connection start instruction from the management device 1. In the case where a plurality of connection start instructions to be processed are present, the physical machine 2 acquires the allocation amount of the resource to the business system corresponding to each of the plurality of connection start instructions. In addition, the physical machine 2 acquires the usage amount of the resource in each business system.

Thereafter, the physical machine 2 determines the connection start instruction that is preferentially processed (hereinafter also referred to as a first connection start instruction) from among the plurality of connection start instructions based on the acquired allocation amount of the resource and the acquired usage amount of the resource.

That is, the physical machine 2 in the present embodiment reduces the number of the connections set between the management device 1 and the physical machine 2 by collectively managing the connection start instructions corresponding to the individual business systems. Hereinafter, the physical machine 2 in a first embodiment will be described.

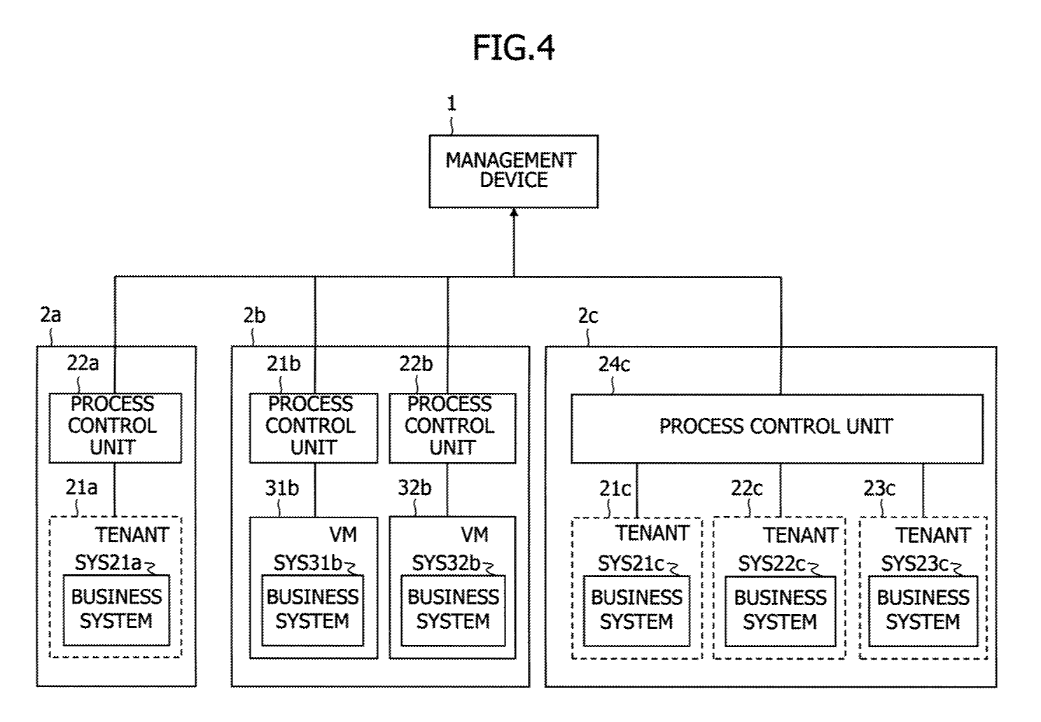

FIG. 4 is a view for explaining the physical machine 2 in the first embodiment. As illustrated in FIG. 4, the CPU (not illustrated) of the physical machine 2a operates as a process control unit 22a, and the CPU (not illustrated) of the physical machine 2b operates as each of a process control unit 21b and a process control unit 22b. In addition, the CPU (not illustrated) of the physical machine 2c operates as a process control unit 24c. As illustrated in FIG. 4, the process control units 22a, 21b, 22b, and 24c perform control so as to reduce the number of the connections set between the management device 1 and the physical machine 2. Note that, hereinafter, the process control units 22a, 21b, 22b, and 24c are also collectively referred to as process control units 20.

Specifically, in an example illustrated in FIG. 4, even in the case where the process control unit 24c receives a plurality of connection start instructions to the business systems SYS21c, SYS22c, and SYS23c configured in the tenants 21c, 22c, and 23c, the process control unit 24c does not perform processes resulting from the individual connection start instructions at the same time. For example, the process control unit 24c determines priorities of the plurality of connection start instructions, and sequentially processes the connection start instructions in descending order of the priority of the connection start instruction such that the number of the connections set between the management device 1 and the physical machine 2c is equal to or less than a predetermined number (e.g., one) constantly.

With this, it becomes possible for each process control unit 20 to reduce the number of the connections set between the management device 1 and each physical machine 2. Accordingly, it becomes possible for the cloud service provider to manage the physical machines 2 that constitute the large-scale public cloud environment while preventing an increase in the number of the management devices 1 to be provided.

Note that, in the example illustrated in FIG. 4, the virtual machine 31b and the virtual machine 32b are generated in the physical machine 2b. In the case where the resources of the virtual machine 31b are divided into a plurality of tenants, there is a possibility that a plurality of business systems are configured in the virtual machine 31b. Similarly, in the case where the resources of the virtual machine 32b are divided into a plurality of tenants, there is a possibility that a plurality of business systems are configured in the virtual machine 32b. Accordingly, as illustrated in FIG. 4, the CPU of the physical machine 2b may operate as each of the process control unit 21b that controls the connection start instruction corresponding to the business system configured in the virtual machine 31b and the process control unit 22b that controls the connection start instruction corresponding to the business system configured in the virtual machine 32b. That is, the CPU of each physical machine 2 may operate as the process control unit 20 for each virtual machine 3 generated in each physical machine 2.

[Hardware Configurations of Management Device and Physical Machine]

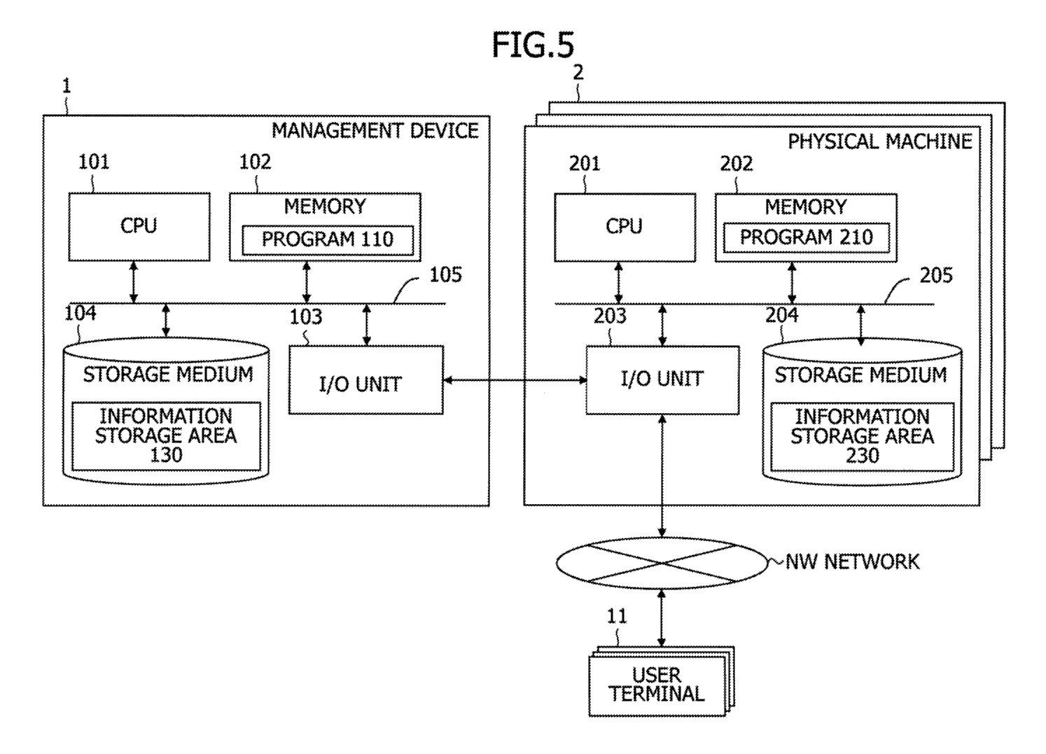

Next, hardware configurations of the management device 1 and the physical machine 2 will be described. FIG. 5 is a view illustrating the hardware configurations of the management device 1 and the physical machine 2. Note that the hardware configuration of the physical machine 2 illustrated in FIG. 5 corresponds to the hardware configuration of each of the physical machines 2a, 2b, and 2c explained in FIG. 4.

The management device 1 has a CPU 101 serving as a processor, a memory 102, an external interface (I/O unit) 103, and a storage medium 104. The individual units are connected to each other via a bus 105.

The storage medium 104 stores, e.g., a program 110 for performing a process for managing the connection set between the management device 1 and the physical machine 2 (hereinafter also referred to as a connection control process) in a program storage area (not illustrated) in the storage medium 104. In addition, the storage medium 104 has an information storage area 130 (hereinafter also referred to as a storage unit 130) that stores, e.g., information that is used when the connection control process is performed.

As illustrated in FIG. 5, the CPU 101 loads the program 110 into the memory 102 from the storage medium 104 when the program 110 is executed, and performs the connection control process in cooperation with the program 110. The external interface 103 performs, e.g., communication with each physical machine 2.

The physical machine 2 has a CPU 201 serving as a processor, a memory 202, an external interface (I/O unit) 203, and a storage medium 204. The individual units are connected to each other via a bus 205.

The storage medium 204 stores, e.g., a program 210 for performing a process for controlling the connection start instruction to the physical machine 2 from the management device 1 (hereinafter also referred to as a process control process) in a program storage area (not illustrated) in the storage medium 204. In addition, the storage medium 204 has an information storage area 230 (hereinafter also referred to as a storage unit 230) that stores, e.g., information that is used when the process control process is performed.

As illustrated in FIG. 5, the CPU 201 loads the program 210 into the memory 202 from the storage medium 204 when the program 210 is executed, and performs the process control process in cooperation with the program 210.

The external interface 203 performs, e.g., communication with the management device 1. In addition, the external interface 203 performs, e.g., communication with a user terminal 11 used by the user for receiving the provision of the service via a network NW that includes the Internet or the like.

[Function of Management Device]

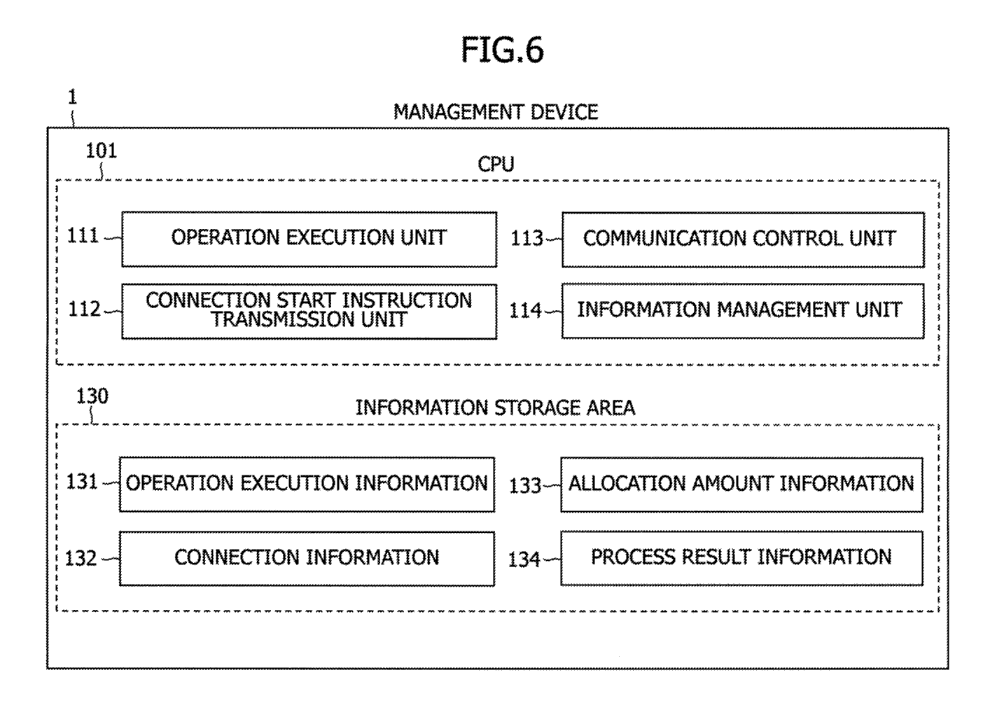

Next, the function of the management device 1 will be described. FIG. 6 is a functional block diagram of the management device 1.

The CPU 101 of the management device 1 cooperates with the program 110 to thereby operate as, e.g., an operation execution unit 111, a connection start instruction transmission unit 112, a communication control unit 113, and an information management unit 114. In addition, in the information storage area 130, for example, operation execution information 131, connection information 132, allocation amount information 133, and process result information 134 are stored.

The operation execution unit 111 performs, e.g., a process for collecting information indicative of the operational status of the business system configured in the physical machine 2 (hereinafter also referred to as an operation process simply). Specifically, the operation execution unit 111 refers to the operation execution information 131 that includes information indicative of the date and time when each operation process is performed. Subsequently, the operation execution unit 111 instructs the connection start instruction transmission unit 112 to transmit the connection start instruction to the physical machine 2 on the date and time indicated by the operation execution information 131.

Note that the operation execution information 131 may be pre-stored in the information storage area 130 by the service provider.

After the operation execution unit 111 performs the collection of the information indicative of the operational status of the business system from the physical machine 2, the operation execution unit 111 refers to the collected information, and performs detection of the business system in which an abnormality is present. A specific example of the operation execution information 131 will be described later.

In the case where the connection start instruction transmission unit 112 receives the instruction from the operation execution unit 111, the connection start instruction transmission unit 112 transmits the connection start instruction to the physical machine 2. That is, in the case where the connection is set between the management device 1 and the physical machine 2, the connection start instruction transmission unit 112 causes the physical machine 2 to perform the process for performing the setting. With this, it becomes possible for the management device 1 to reduce the number of ephemeral ports of the management device 1 to be used.

Note that the connection start instruction transmission unit 112 performs the transmission of the connection start instruction to the physical machine 2 by performing multicast transmission or unicast transmission using a user datagram protocol (UDP). With this, when the connection start instruction is transmitted to the physical machine 2, it becomes possible for the management device 1 to prevent the connection from being set between the management device 1 and the physical machine 2. Accordingly, it becomes possible for the management device 1 to prevent the number of the ephemeral ports of the management device 1 to be used or the number of the descriptor from reaching the upper limit due to the transmission of the connection start instruction to the physical machine 2.

The communication control unit 113 receives a transmission request of an execution instruction (hereinafter also referred to as a transmission request simply) of a process resulting from the connection start instruction (hereinafter also referred to as a first process simply) transmitted by the physical machine 2. The first process is a process that each physical machine 2 needs to be caused to execute in order for the management device 1 to perform the operation process such as a process for transmitting the information indicative of the operational status of the business system to the management device 1.

In the case where the communication control unit 113 has received the transmission request from the physical machine 2, the communication control unit 113 transmits the execution instruction of the first process to the physical machine 2 (the physical machine 2 that has transmitted the transmission request). Further, the communication control unit 113 receives a process result of the first process transmitted by the physical machine 2.

In addition, the communication control unit 113 refers to the connection information 132 that manages the connection set between the management device 1 and the physical machine 2. Subsequently, in the case where the number of the physical machines 2 that are connected with the management device 1 (hereinafter also referred to as connection destination devices 2) exceeds a predetermined number, the communication control unit 113 disconnects the connection set between the management device 1 and the connection destination device 2 until the number of the physical machines 2 connected with the management device 1 becomes equal to or less than the predetermined number. Specifically, for example, the communication control unit 113 selects the connection with which the communication is unlikely to be performed in the future, and disconnects the selected connection. With this, it becomes possible for the management device 1 to prevent the number of the descriptor of the management device 1 from reaching the upper limit due to the connection set between the management device 1 and the physical machine 2. A specific example of the connection information 132 will be described later. In addition, the detail of the process in the case where the communication control unit 113 selects the connection to be disconnected will be described later.

In the case where the communication control unit 113 has received the process result of the first process (hereinafter also referred to as a process result simply), the information management unit 114 stores the received process result in the information storage area 130 as the process result information 134. In addition, in the case where a new connection between the management device 1 and the physical machine 2 is set or in the case where the connection between the management device 1 and the physical machine 2 is disconnected, the information management unit 114 updates the connection information 132 stored in the information storage area 130.

The allocation amount information 133 is information indicative of the allocation amount of the resource to the business systems corresponding to each connection start instruction. Note that the allocation amount information 133 may be preset in the information storage area 130 by the cloud service provider.

[Function of Physical Machine]

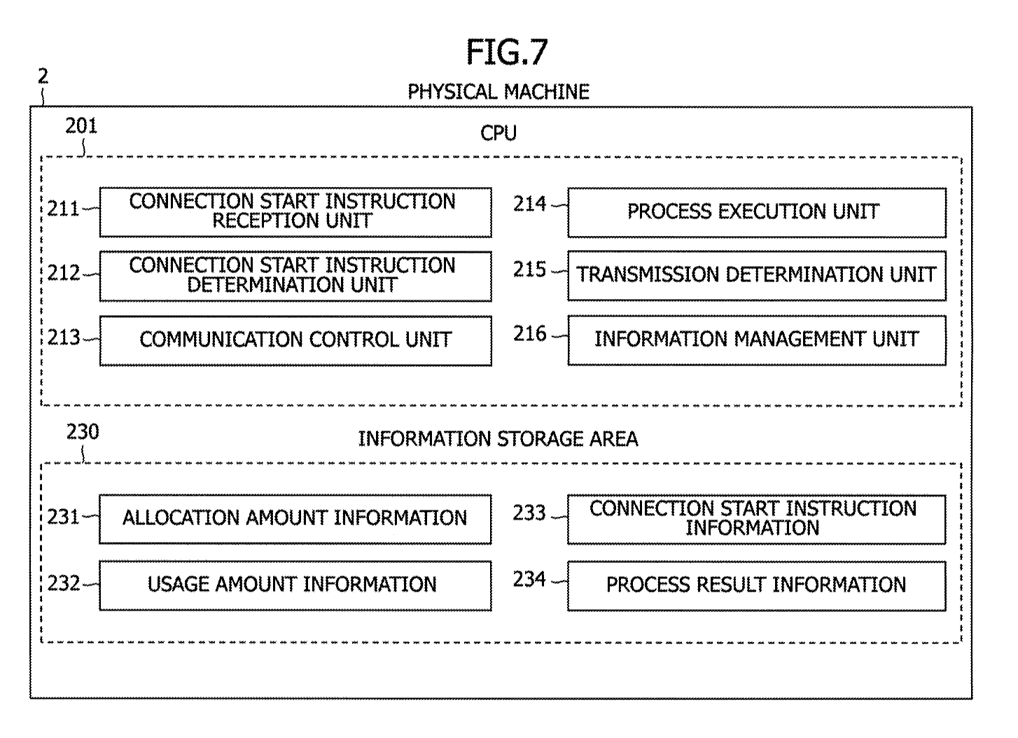

Next, the function of the physical machine 2 will be described. FIG. 7 is a functional block diagram of the physical machine 2.

The CPU 201 of the physical machine 2 cooperates with the program 210 to thereby operate as, e.g., a connection start instruction reception unit 211 (hereinafter also referred to as a reception unit 211 simply) and a connection start instruction determination unit 212 (hereinafter also referred to as a determination unit 212 simply). In addition, the CPU 201 of the physical machine 2 cooperates with the program 210 to thereby operate as, e.g., a communication control unit 213, a process execution unit 214, a transmission determination unit 215, and an information management unit 216. Note that the connection start instruction determination unit 212 corresponds to the process control unit 20 explained in FIG. 4. The process execution unit 214 is provided for each business system configured in the physical machine 2.

Further, in the information storage area 230, for example, allocation amount information 231, usage amount information 232, connection start instruction information 233, and process result information 234 are stored.

The connection start instruction reception unit 211 receives the connection start instruction transmitted by the management device 1.

Subsequently, the information management unit 216 stores the connection start instruction received by the connection start instruction reception unit 211 in the information storage area 230 as the connection start instruction information 233.

In the case where the connection start instruction information 233 including sets of information corresponding to each connection start instruction is stored in the information storage area 230, the connection start instruction determination unit 212 acquires the allocation amount information 231 and the usage amount information 232.

The allocation amount information 231 is information indicative of the allocation amount of the resource to the business systems corresponding to each connection start instruction. Note that the allocation amount information 231 is the same information as the allocation amount information 133, and may be preset in the information storage area 230 by the cloud service provider.

The usage amount information 232 is information indicative of the usage amount of the resource in each business system. Specifically, the usage amount information 232 is information indicative of the current usage amount of the resource in each business system, and may be acquired by the connection start instruction determination unit 212. Note that, when the connection start instruction determination unit 212 has acquired the usage amount information 232, the information management unit 216 may store the usage amount information 232 in the information storage area 230.

The connection start instruction determination unit 212 determines, based on the allocation amount information 231 and the usage amount information 232, the first connection start instruction that is preferentially processed from among the set of information included in the connection start instruction information 233. That is, the connection start instruction determination unit 212 determines, e.g., the connection start instruction having the highest priority as the first connection start instruction from among the set of information included in the connection start instruction information 233 stored in the information storage area 230. With this, it becomes possible for the physical machine 2 to sequentially execute the processes from the process resulting from the connection start instruction having the highest priority. Accordingly, it becomes possible for the management device 1 to reduce the number of the connections set between the management device 1 and each physical machine 2.

After the connection start instruction determination unit 212 determines the first connection start instruction, the communication control unit 213 performs the setting of the connection with the management device 1. Thereafter, the communication control unit 213 transmits the transmission request of the execution instruction of the process (the first process) resulting from the first connection start instruction to the management device 1. In addition, the communication control unit 213 receives the execution instruction of the first process transmitted by the management device 1. Further, in the case where the process execution unit 214 has executed the first process, the communication control unit 213 transmits the process result of the executed first process to the management device 1.

In the case where the communication control unit 213 has received the execution instruction of the first process from the management device 1, the process execution unit 214 executes the first process. Subsequently, the information management unit 216 stores the process result of the first process executed by the process execution unit 214 in the information storage area 230 as the process result information 234.

In the case where the process result information 234 including sets of information to corresponding to each first process to be transmitted is stored in the information storage area 230, the transmission determination unit 215 determines, e.g., the information corresponding to the first process having the oldest date and time of the execution as the information that is preferentially transmitted to the management device 1.

### First Embodiment

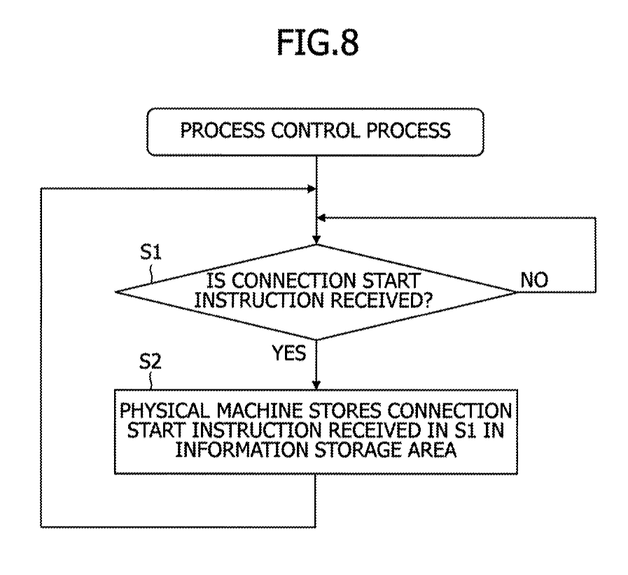

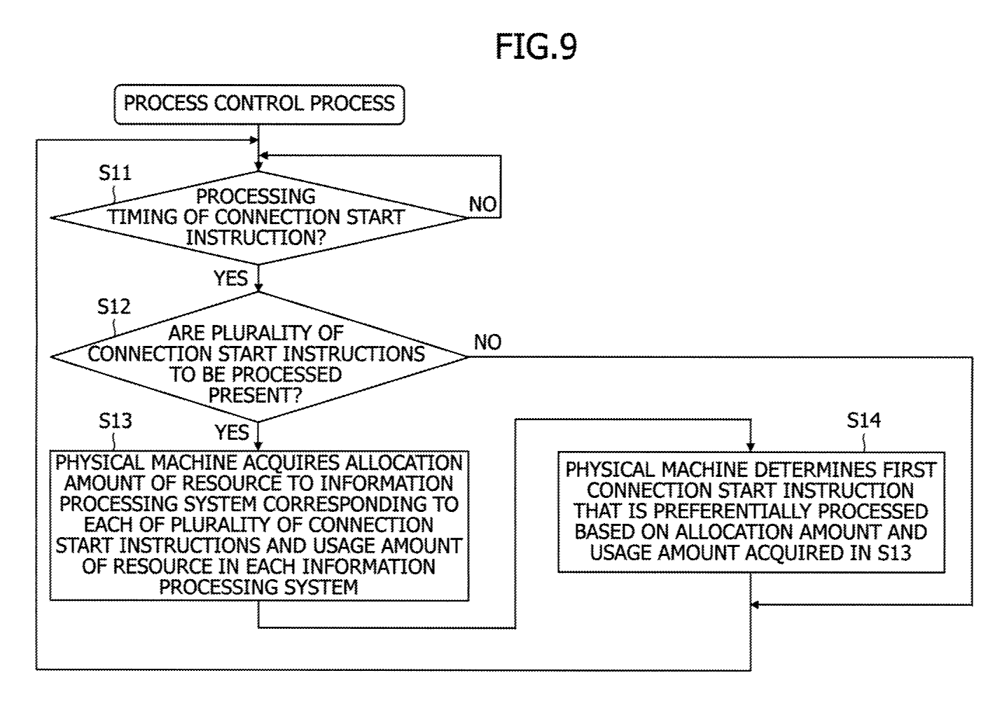

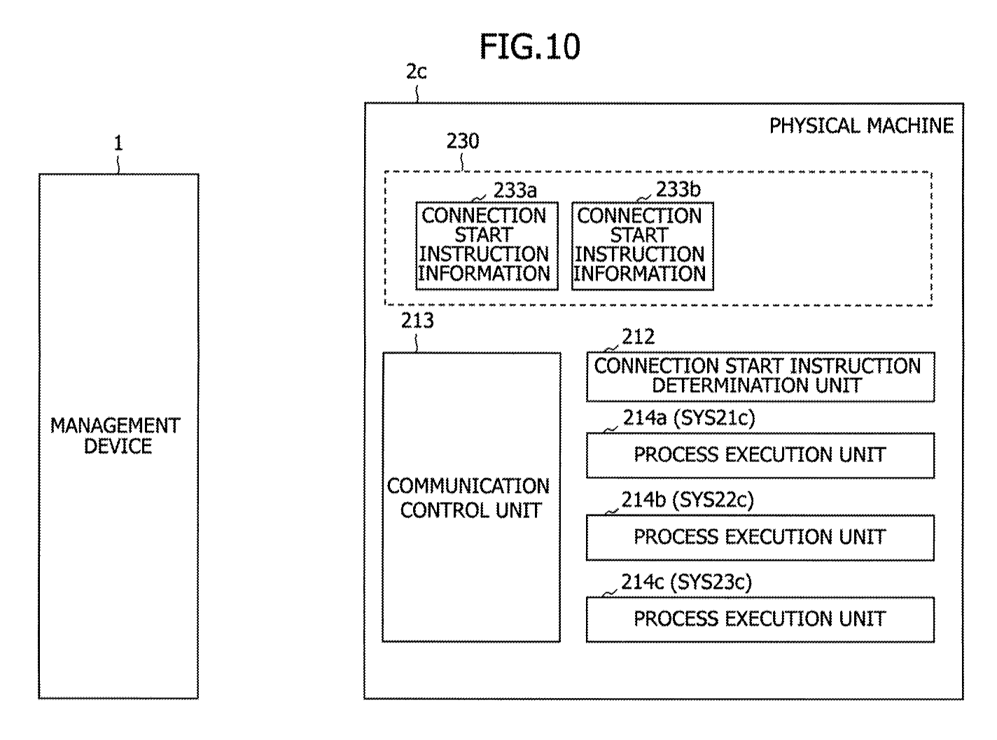

Next, the first embodiment will be described. FIGS. 8 and 9 are flowcharts for explaining the outline of the process control process in the first embodiment. In addition, FIGS. 10 to 13 are views for explaining the outline of the process control process in the first embodiment. With reference to FIGS. 10 to 13, the outline of the process control process in FIGS. 8 and 9 will be described.

First, the physical machine 2c illustrated in FIG. 10 will be described. The physical machine 2c illustrated in FIG. 10 corresponds to the physical machine 2c explained in FIG. 4.

In the information storage area 230 of the physical machine 2c illustrated in FIG. 10, sets of connection start instruction information 233a and connection start instruction information 233b included in connection start instruction information 233 received already from the management device 1 are stored. In the physical machine 2c illustrated in FIG. 10, process execution units 214a, 214b, and 214c execute the first processes corresponding to the business systems SYS21c, SYS22c, and SYS23c explained in FIG. 4. Note that, in the physical machine 2c illustrated in FIG. 10, the description of the connection start instruction reception unit 211, the transmission determination unit 215, the information management unit 216, and each business system will be omitted. Hereinafter, with reference to FIGS. 8 and 9, the outline of the process control process in the first embodiment will be described.

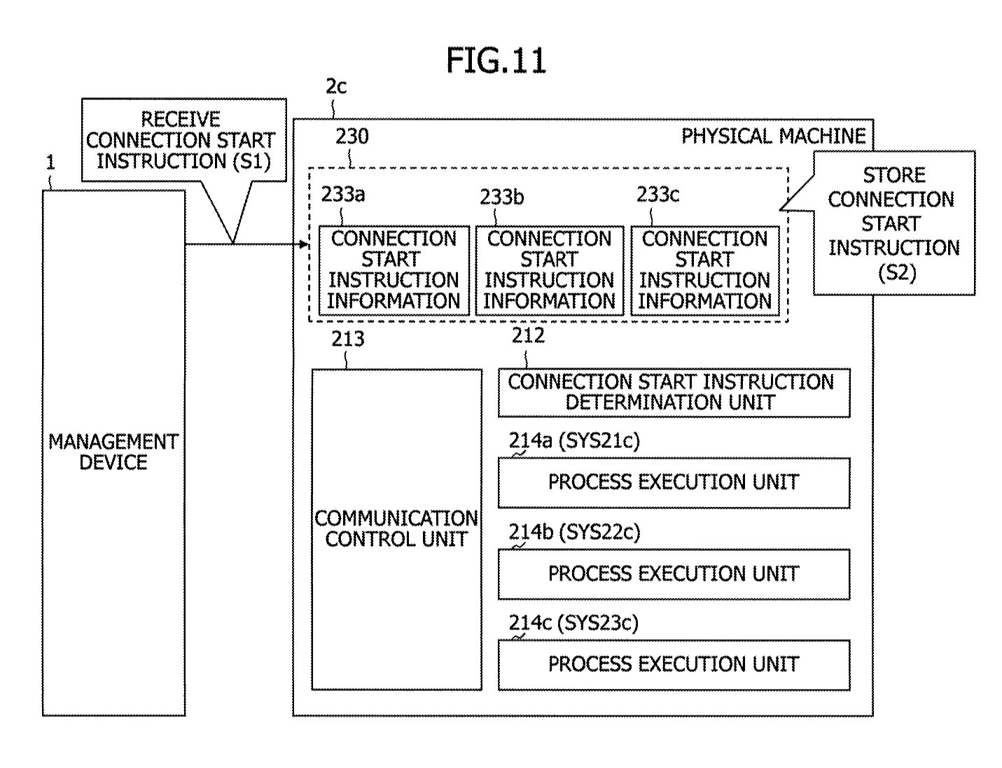

As illustrated in FIG. 8, the connection start instruction reception unit 211 of the physical machine 2 stands by until the connection start instruction reception unit 211 receives the connection start instruction from the management device 1 (NO in S1). In the case where the connection start instruction reception unit 211 has received the connection start instruction (YES in S1), as illustrated in FIG. 11, the information management unit 216 of the physical machine 2 stores the connection start instruction received in the process in S1 in information storage area 230 as the connection start instruction information 233 (S2). Specifically, as illustrated in FIG. 11, the information management unit 216 newly stores the connection start instruction received from the management device 1 in the information storage area 230 as connection start instruction information 233c included in connection start instruction information 233.

On the other hand, as illustrated in FIG. 9, the connection start instruction determination unit 212 of the physical machine 2 stands by until a processing timing of the connection start instruction comes (NO in S11). The processing timing of the connection start instruction may be, e.g., a timing when the connection start instruction reception unit 211 receives the connection start instruction. In addition, the processing timing of the connection start instruction may be, e.g., a timing when the connection start instruction determination unit 212 detects that the information is stored in the information storage area 230. Subsequently, in the case where the processing timing of the connection start instruction has come (YES in S11), the connection start instruction determination unit 212 determines whether or not the connection start instruction information 233 including sets of information to be process is stored in the information storage area 230 (S12).

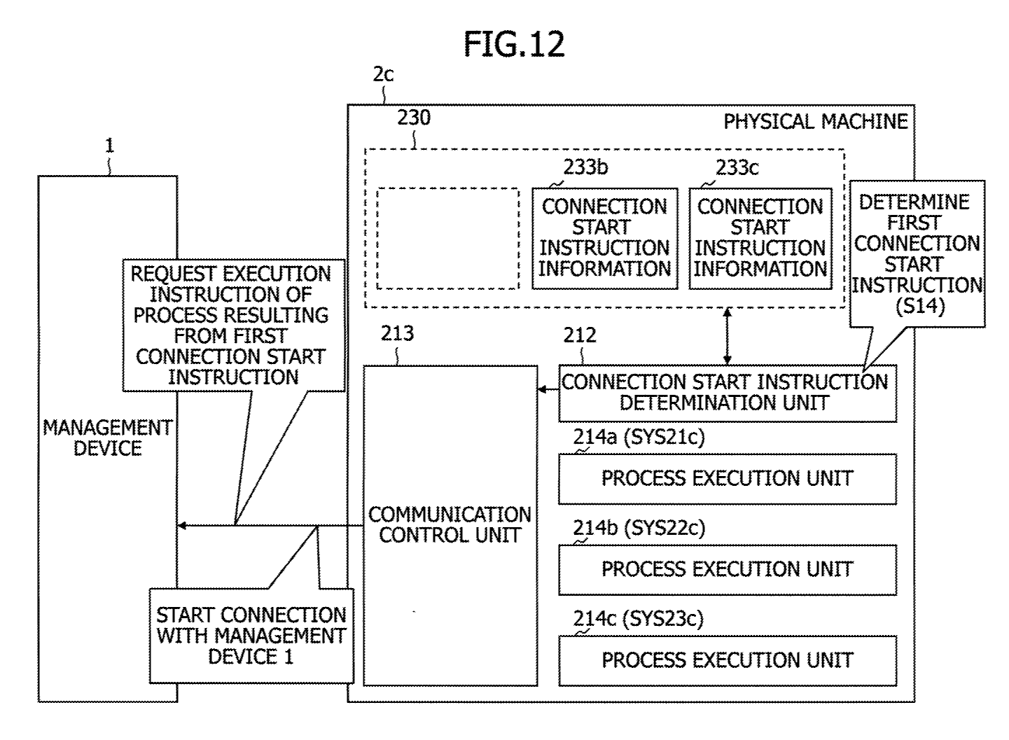

As a result, in the case where it is determined that the connection start instruction information 233 including sets of information to be processed is stored (YES in S12), the connection start instruction determination unit 212 acquires the allocation amount information 231 of the resource to the business systems corresponding to each connection start instruction information from the information storage area 230 (S13). In addition, in this case, the connection start instruction determination unit 212 acquires the usage amount information 232 of the resource in each business system (S13). Thereafter, as illustrated in FIG. 12, the connection start instruction determination unit 212 determines the first connection start instruction that is preferentially processed based on the allocation amount information 231 and the usage amount information 232 that are acquired in the process in S13 (S14).

That is, in the case where the physical machine 2 has received a plurality of connection start instructions to the individual business systems, the physical machine 2 collectively manages the received connection start instructions. Subsequently, the physical machine 2 sequentially processes the connection start instructions from, e.g., the connection start instruction having the highest priority from among a plurality of connection start instructions in descending order of the priority. With this, the physical machine 2 does not need to set the connection between the management device 1 and each business system, and it becomes possible to reduce the number of the connections set between the management device 1 and each physical machine 2. Accordingly, it becomes possible for the cloud service provider to manage the physical machines 2 that constitute the large-scale public cloud environment while preventing the increase in the number of the management devices 1 that the cloud service provider needs to provide.

On the other hand, in the case where it is determined that the connection start instruction information 233 including sets of information to be processed is not stored (NO in S12), the connection start instruction determination unit 212 determines the connection start instruction information corresponding to the stored information as the first connection start instruction.

Thereafter, the communication control unit 213 of the physical machine 2 sets the connection with the management device 1, and requests the execution instruction of the first process. Specifically, as illustrated in FIG. 12, the communication control unit 213 requests the execution instruction of the first process corresponding to, e.g., the connection start instruction information 233a.

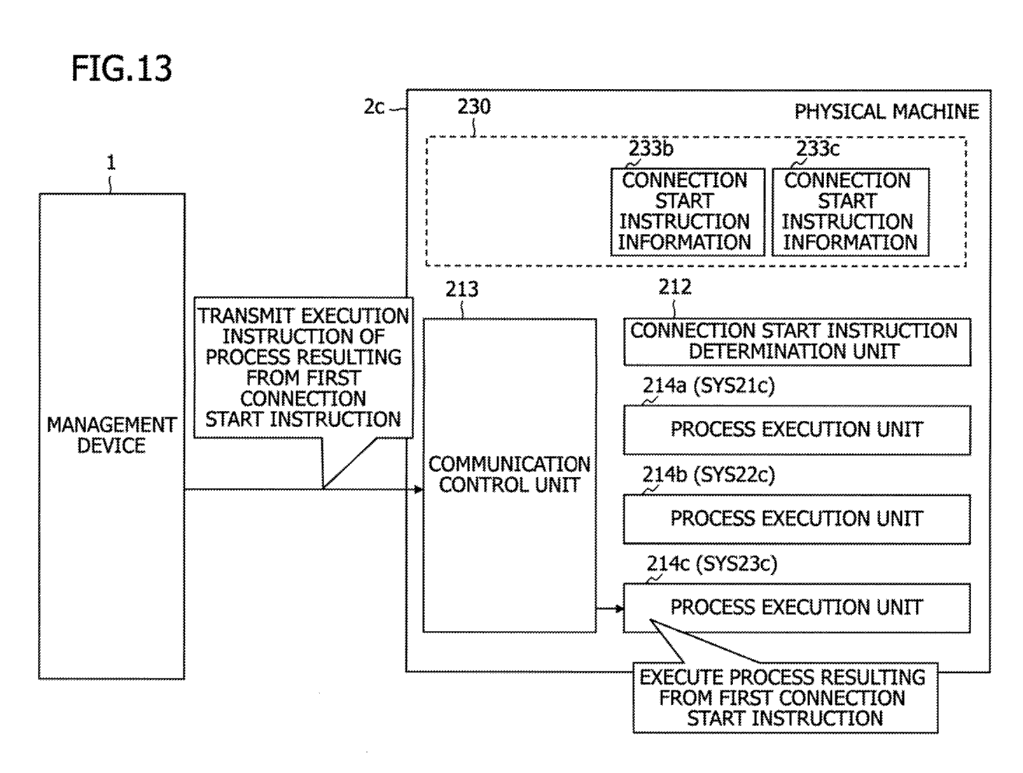

Subsequently, in the case where the communication control unit 213 has received the execution instruction of the first process, the process execution unit 214 of the physical machine 2 executes the first process. Specifically, in the case where the received execution instruction of the first process is the execution instruction corresponding to the business system SYS23c, as illustrated in FIG. 13, the process execution unit 214c performs the execution of the first process. Further, the communication control unit 213 transmits the process result of the first process to the management device 1.

Thus, the physical machine 2 of the present embodiment receives the connection start instruction from the management device 1 that makes a process request to the physical machine 2. Subsequently, in the case where a plurality of connection start instructions to be processed are present, the physical machine 2 acquires the allocation amount information 231 of the resource to the business systems corresponding to each connection start instruction. In addition, in this case, the physical machine 2 acquires the usage amount information 232 of the resource in each information processing system. Thereafter, the physical machine 2 determines the first connection start instruction that is preferentially processed from among the plurality of connection start instructions based on the allocation amount information 231 and the usage amount information 232.

With this, the physical machine 2 does not need to set the connection between the management device 1 and each business system, and it becomes possible to reduce the number of the connections set between each physical machine 2 and the management device 1. Accordingly, it becomes possible for the cloud service provider to manage the physical machines 2 that constitute the large-scale public cloud environment while preventing the increase in the number of the management devices 1 that the cloud service provider needs to provide.

### Detail of First Embodiment

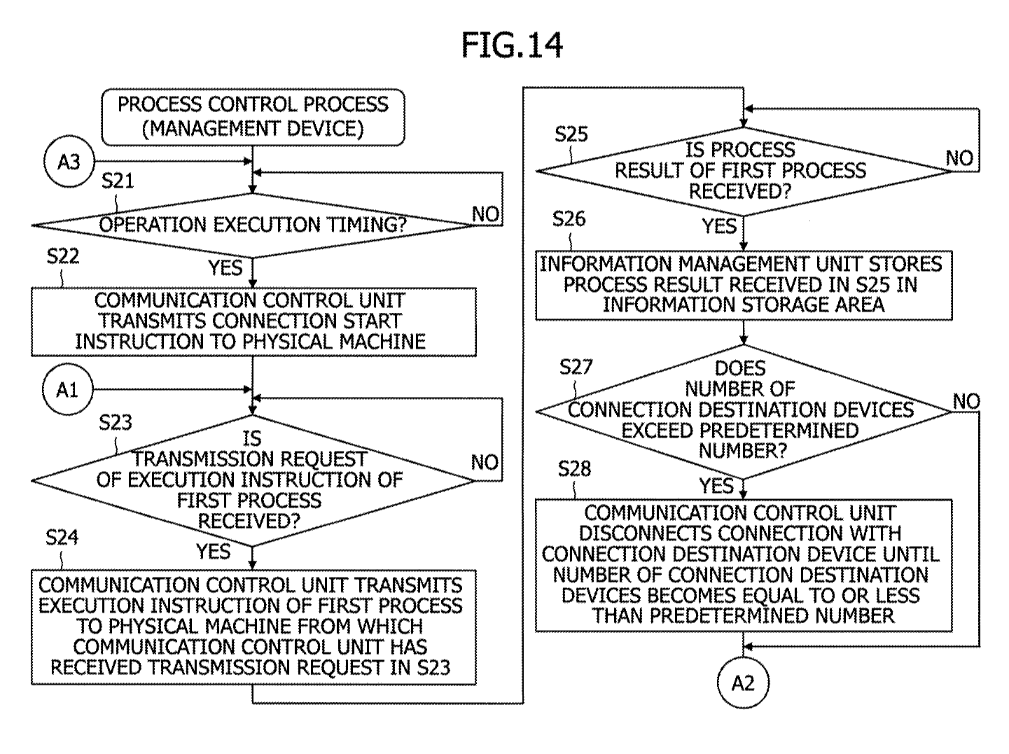

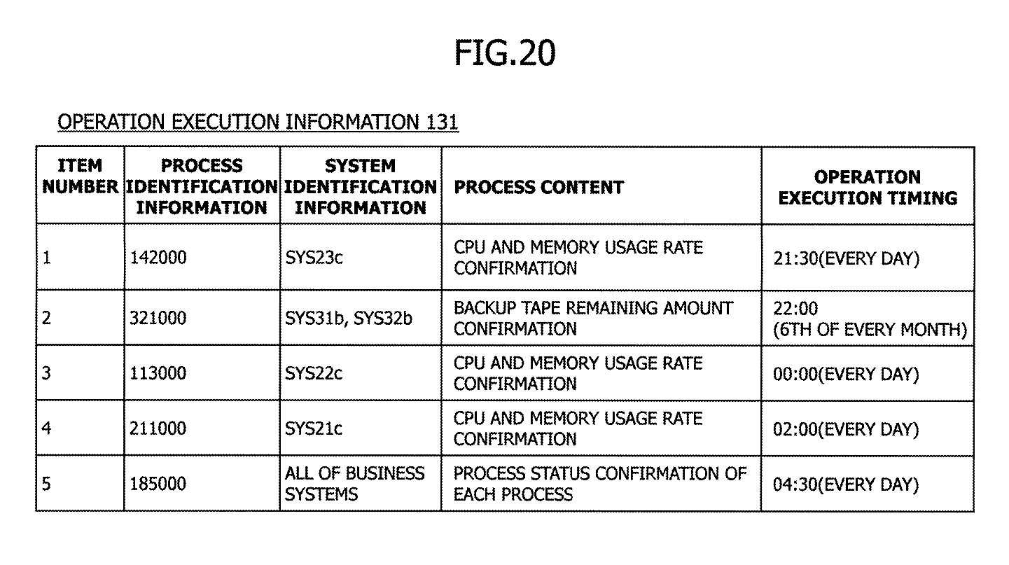

Next, the detail of the first embodiment will be described. FIGS. 14 to 19 are flowcharts for explaining the detail of the process control process in the first embodiment. In addition, FIGS. 20 to 30 are views for explaining the detail of the process control process in the first embodiment. With reference to FIGS. 20 to 30, the detail of the process control process in FIGS. 14 to 19 will be described.

[Process Control Process in Management Device]

The operation execution unit 111 of the management device 1 stands by until an operation execution timing comes (NO in S21). The operation execution timing may be the date and time on which information is included in the operation execution information 131. That is, the operation execution timing may be the date and time predetermined by the cloud service provider as the date and time when the operation process is performed. Hereinafter, a specific example of the operation execution information 131 will be described.

[Specific Example of Operation Execution Information]

FIG. 20 is a view for explaining the specific example of the operation execution information 131. The operation execution information 131 illustrated in FIG. 20 has, as items, “item number” for identifying each information in the operation execution information 131 and “process identification information” for identifying each operation process. In addition, the operation execution information 131 illustrated in FIG. 20 has, as items, “system identification information” for identifying the business system that is instructed to execute the process (the first process) for executing the operation process and “process content” indicative of the content of the operation process. Further, the operation execution information 131 illustrated in FIG. 20 has, as an item, “operation execution timing” indicative of the execution timing of the operation process.

Specifically, in the operation execution information 131 illustrated in FIG. 20, for information having “item number” of “1”, “142000” is set as “process identification information”, and “SYS23c” is set as “system identification information”. In addition, in the operation execution information 131 illustrated in FIG. 20, for the information having “item number” of “1”, “CPU and memory usage rate confirmation” is set as “process content”, and “21:30 (every day)” is set as “operation execution timing”.

That is, the operation execution unit 111 refers to the operation execution information 131 illustrated in FIG. 20, and executes the confirmation of the usage rates of the CPU and the memory of the business system SYS23c at 21:30 every day. With this, it becomes possible for the cloud service provider to automatically execute the operation process to each business system based on the predetermined content of the operation execution information 131.

In the case where the new physical machine 2 that is managed by the management device 1 is added, the service provider may add information indicative of the business system configured in the newly added physical machine 2 to the information set in “system identification information” of the operation execution information 131. The description of the other information included in FIG. 20 will be omitted.

Returning to FIG. 14, in the case where the operation execution timing has come (YES in S21), the communication control unit 113 of the management device 1 transmits the connection start instruction to the physical machine 2 in which the business system corresponding to the operation process to be executed operates (S22). Specifically, for example, the communication control unit 113 refers to the operation execution information 131, and performs the multicast transmission of the connection start instruction or the unicast transmission thereof to the physical machine in which the business system on which the information is set in “system identification information” of the operation process to be executed operates.

Thereafter, the communication control unit 113 stands by until the communication control unit 113 receives the transmission request of the execution instruction of the first process from the physical machine 2 to which the connection start instruction has been transmitted (NO in S23). Specifically, the communication control unit 113 stands by until the physical machine 2 to which the connection start instruction has been transmitted sets the connection with the management device 1, and transmits the transmission request of the execution instruction of the first process. Subsequently, in the case where the communication control unit 113 has received the transmission request of the execution instruction of the first process (YES in S23), the communication control unit 113 transmits the execution instruction of the first process to the physical machine 2 from which the communication control unit 113 has received the transmission request in the process in S23 (S24).

That is, in the case where the setting of the connection is performed between the management device 1 and the physical machine 2, the physical machine 2 performs the process for performing the setting of the connection. With this, it becomes possible for the management device 1 to suppress the use of the ephemeral ports of the management device 1.

Subsequently, the communication control unit 113 stands by until the communication control unit 113 receives the process result of the first process from the physical machine 2 to which the execution instruction of the first process has been transmitted (NO in S25). In the case where the communication control unit 113 has received the process result of the first process (YES in S25), the information management unit 114 of the management device 1 stores the received process result of the first process in the information storage area 130 as the process result information 134 (S26).

Thereafter, the communication control unit 113 refers to the connection information 132, and determines whether or not the number of the connection destination devices 2 connected with the management device 1 (including the physical machine 2 that has executed the first process) exceeds the predetermined number (the number predetermined by the cloud service provider) (S27). As a result, in the case where the number of the connection destination devices 2 exceeds the predetermined number (YES in S27), the communication control unit 113 disconnects the connection with the connection destination device 2 until the number of the connection destination devices 2 becomes equal to or less than the predetermined number (S28). With this, it becomes possible for the communication control unit 113 to prevent the number of the descriptor of the management device 1 from reaching the upper limit due to the connection set between the management device 1 and the physical machine 2.

Specifically, the communication control unit 113 determines the business system for which there is another business system which has the same allocation amount information 231 as that of the business system and in which the process that needs the transmission and reception of information to and from the management device 1 (e.g., the first process) is being executed. Subsequently, the communication control unit 113 preferentially disconnects the connection with the physical machine other than the physical machine 2 in which the determined business system operates.

That is, for example, the service provider configures the business system for each user and performs the provision of the service to each user. Herein, when the business system for a given user is configured in each of a plurality of tenants, there are cases where the service provider creates the operation execution information 131 such that the same operation process is performed in each of the plurality of tenants. Accordingly, in the case where the operation process is being executed in a given business system, the management device 1 can determine that there is a possibility that the same operation process is executed in another business system configured for the same user. Consequently, the management device 1 does not disconnect not only the connection with the physical machine in which the business system in which the operation process is being executed operates but also the connection with the physical machine in which another business system configured for the same user operates.

With this, it becomes possible for the management device 1 to reduce frequency of disconnection of the connection with which the communication is likely to be performed in the future. Accordingly, it becomes possible for the management device 1 to reduce the number of times of the disconnection and resetting of the connection with the physical machine 2.

Note that there are cases where, among the business systems configured in the tenants rented to the service provider, the cloud service provider does not have information on the business system configured for the same user. Accordingly, for example, the management device 1 may refer to the allocation amount information 133 of each business system configured in the tenant rented to the service provider, and may determine that the business systems having the same allocation amount information 133 are the business systems configured for the same user. In addition, for example, the management device 1 may check the configuration of software installed in each business system configured in the tenant rented to the service provider, and determine that the business systems having the same configuration of the software are the business systems configured for the same user. Hereinafter, specific examples of the connection information 132 and the allocation amount information 133 will be described.

[Specific Example of Connection Information]

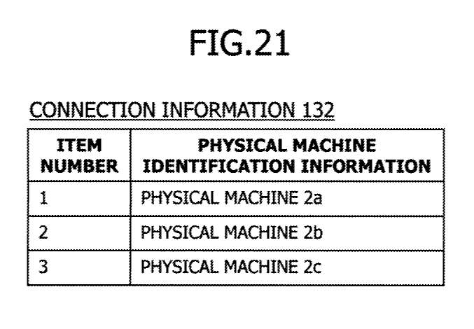

FIG. 21 is a view for explaining the specific example of the connection information 132. The connection information 132 illustrated in FIG. 21 has, as items, “item number” for identifying each information in the connection information 132 and “physical machine identification information” for identifying the physical machine 2 that has the connection with the management device 1.

Specifically, in the connection information 132 illustrated in FIG. 21, “physical machine 2a” is set as “physical machine identification information” for information having “item number” of “1”, and “physical machine 2b” is set as “physical machine identification information” for information having “item number” of “2”. In addition, in the connection information 132 illustrated in FIG. 21, “physical machine 2c” is set as “physical machine identification information” for information having “item number” of “3”. That is, the connection information 132 illustrated in FIG. 21 indicates that the connections are set between all of the physical machines 2 explained in FIG. 4 or the like and the management device 1.

[Specific Example of Allocation Amount Information]

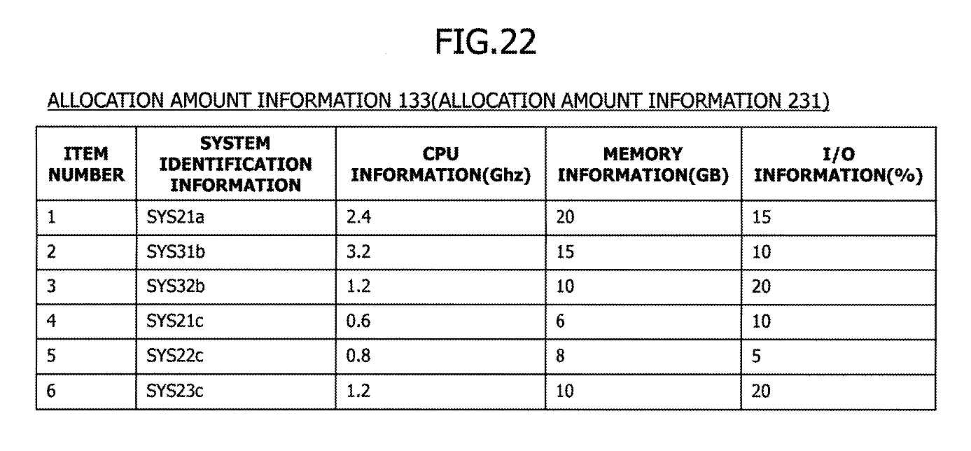

Next, the specific example of the allocation amount information 133 (the allocation amount information 231) will be described. FIG. 22 is a view for explaining the specific example of the allocation amount information 133. The allocation amount information 133 illustrated in FIG. 22 has, as items, “item number” for identifying each information in the allocation amount information 133, “system identification information” for identifying each business system, and “CPU information” indicative of the allocation amount of the CPU allocated to each business system. In addition, the allocation amount information 133 illustrated in FIG. 22 has, as an item, “memory information” indicative of the allocation amount of the memory allocated to each business system. Further, the allocation amount information 133 illustrated in FIG. 22 has, as an item, “I/O information” indicative of the allocation rate of an I/O resource allocated to each business system (the allocation rate to the I/O resource of the physical machine 2 in which each business system in configured).

Specifically, in the allocation amount information 133 illustrated in FIG. 22, for information having “item number” of “1”, “SYS21a” is set as “system identification information”, “2.4 (Ghz)” is set as “CPU information”, and “20 (GB)” is set as “memory information”. In addition, in the allocation amount information 133 illustrated in FIG. 22, for the information having “item number” of “1”, “15(%)” is set as “I/O information”.

That is, the information having “item number” of “1” in the allocation amount information 133 illustrated in FIG. 22 indicates that the CPU of 2.4 (Ghz) and the memory of 20 (GB) are allocated to the business system SYS21a. In addition, the information having “item number” of “1” in the allocation amount information 133 illustrated in FIG. 22 indicates that the I/O resource corresponding to 15(%) of the I/O resource of the physical machine 2a is allocated to the business system SYS21a. The description of the other information included in FIG. 22 will be omitted.

[Specific Example of Process in S28]

Next, with reference to FIGS. 21 and 22, a specific example of the process in S28 will be described. Hereinafter, the description will be made on the assumption that the predetermined number in S28 (the number of the physical machines 2 with which the management device 1 can set the connection) is 2 (units).

In the connection information 132 explained in FIG. 21, the physical machines 2 having the connections with the management device 1 are the physical machines 2a, 2b, and 2c. Accordingly, the communication control unit 113 needs to disconnect one of the connections with the physical machines 2a, 2b, and 2c in the process in S28.

Specifically, the communication control unit 113 refers to the allocation amount information 133 explained in FIG. 22, and determines the business system SYS23c and the business system SYS32b having the same allocated resources (information items set in “CPU information”, “memory information”, and “I/O information”). Subsequently, in the case where the process that needs the transmission and reception of information to and from the management device 1 is being executed in at least one of the business systems SYS23c and SYS32b, the communication control unit 113 determines that the connection with the physical machine 2b and the connection with the physical machine 2c are not disconnected. Accordingly, in this case, the communication control unit 113 determines that the connection with the physical machine 2a is disconnected.

On the other hand, in the case where the process that needs the transmission and reception of information to and from the management device 1 is not being executed in the business systems SYS23c and SYS32b, the communication control unit 113 determines that any of the connections with the physical machines 2a, 2b, and 2c is disconnected.

Note that the communication control unit 113 may quantify the number of the other business systems which have the same allocation amount information 231 and in which the process that needs the transmission and reception of information to and from the management device 1 is being executed in terms of scores for each business system. Subsequently, the communication control unit 113 may totalize the scores of the individual business systems for each physical machine 2, and determine that the connection with the physical machine 2 having the lowest score is disconnected.

In addition, for example, the communication control unit 113 may refer to the operation execution information 131, and quantify the scheduled number of times of execution of the transmission and reception of information to and from the management device 1 in terms of scores for each business system. Subsequently, the communication control unit 113 may totalize the scores of the individual business systems for each physical machine 2, and determine that the connection with the physical machine 2 having the lowest score is disconnected.

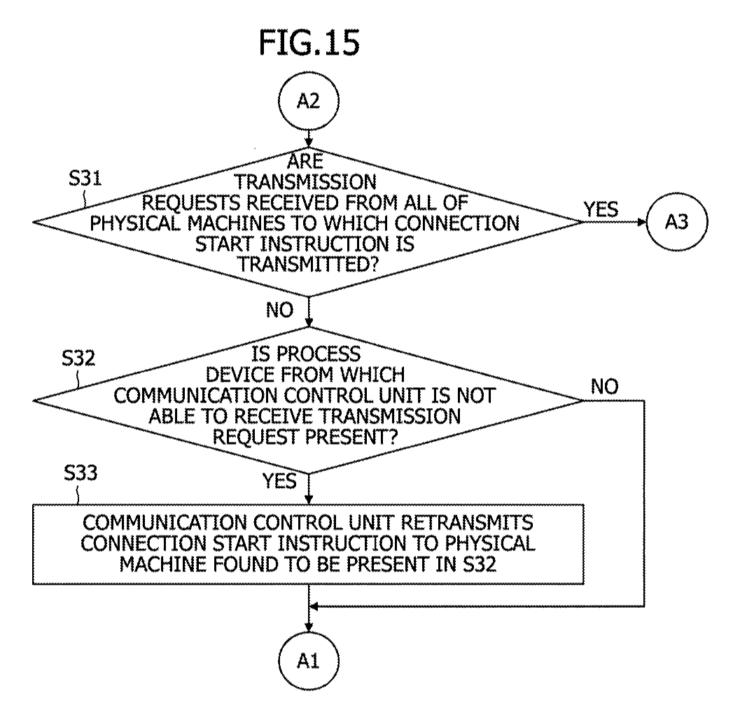

Returning to FIG. 15, the communication control unit 113 determines whether or not the communication control unit 113 has received the process results of the first process from all of the physical machines 2 to which the connection start instructions have been transmitted (S31). As a result, in the case where the communication control unit 113 has received the process results from all of the physical machines 2 to which the connection start instructions have been transmitted (YES in S31), the operation execution unit 111 stands by until the next operation execution timing (NO in S21). That is, in this case, the management device 1 ends the execution of the operation process resulting from the connection start instruction transmitted in the process in S22.

On the other hand, in the case where the communication control unit 113 has not received the transmission requests from all of the physical machines 2 (NO in S31), the communication control unit 113 determines whether or not the physical machine 2 from which the communication control unit 113 is not able to receive the transmission request in spite of a lapse of predetermined time (e.g., 10 minutes) since the transmission of the connection start instruction is present (S32). As a result, in the case where the physical machine 2 from which the communication control unit 113 is not able to receive the transmission request is present (YES in S32), the communication control unit 113 retransmits the connection start instruction transmitted in the process in S22 to the physical machine 2 found to be present in the process in S32 (S33).

That is, in the process in S22, the communication control unit 113 transmits the connection start instruction according to UDP having poor communication reliability. Accordingly, there is a possibility that the physical machine 2 that has not been able to receive the connection start instruction is present among the physical machines 2 to which the communication control unit 113 has transmitted the connection start instructions. Consequently, in the case where the physical machine 2 from which the communication control unit 113 is not able to receive the transmission request in spite of the lapse of the predetermined time since the transmission of the connection start instruction is present, the communication control unit 113 determines that the connection start instruction has not been transmitted to the physical machine 2. With this, it becomes possible for the communication control unit 113 to transmit the connection start instructions to all of the physical machines 2 to which the connection start instructions need to be transmitted.

On the other hand, in the case where the physical machine 2 from which the communication control unit 113 is not able to receive the transmission request is not present (NO in S32), the communication control unit 113 does not execute the process in S33. Subsequently, after the process in S32 or S33, the communication control unit 113 executes the processes in and after S23 again.

[Process Control Process in Physical Machine]

Next, the process control process in the physical machine 2 will be described. As explained in FIG. 8, the connection start instruction reception unit 211 stands by until the connection start instruction reception unit 211 receives the connection start instruction from the management device 1 (NO in S1). Subsequently, in the case where the connection start instruction reception unit 211 has received the connection start instruction (YES in S1), the information management unit 216 stores information corresponding to the connection start instruction received in the process in S1 in the information storage area 230 as the connection start instruction information 233 (S2). Hereinafter, specific examples of the connection start instruction transmitted by the management device 1 and the connection start instruction information 233 stored in the information storage area 230 will be described.

[Specific Example of Connection Start Instruction Transmitted by Management Device (1)]

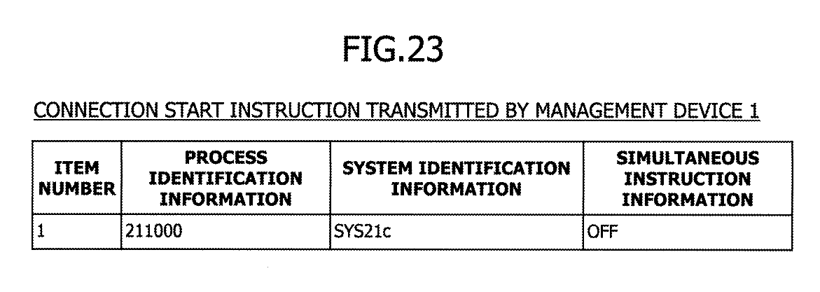

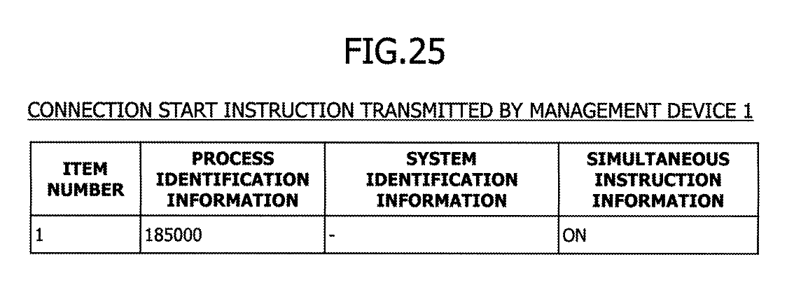

FIGS. 23 and 25 are views for explaining the specific example of the connection start instruction transmitted by the management device 1. The connection start instruction illustrated in each of FIGS. 23 and 25 has, as items, “item number” for identifying each information included in the connection start instruction, “process identification information” for identifying each operation process, and “system identification information” for identifying the business system that is caused to execute the process (the first process) that is needed for the execution of the operation process. In addition, the connection start instruction illustrated in each of FIGS. 23 and 25 has, as an item, “simultaneous instruction information” for identifying whether or not the connection start instruction is the connection start instruction that is transmitted to a plurality of business systems. As “simultaneous instruction information”, “OFF” indicative of the connection start instruction that is transmitted only to one business system and “ON” indicative of the connection start instruction that is transmitted to a plurality of business systems are set.

Specifically, in the connection start instruction illustrated in FIG. 23, for information having “item number” of “1”, “211000” is set as “process identification information”, “SYS21c” is set as “system identification information”, and “OFF” is set as “simultaneous instruction information”. The description of FIG. 25 will be made later.

[Specific Example of Connection Start Instruction Information Stored in Information Storage Area (1)]

Next, a specific example of the connection start instruction information 233 stored in the information storage area 230 will be described.

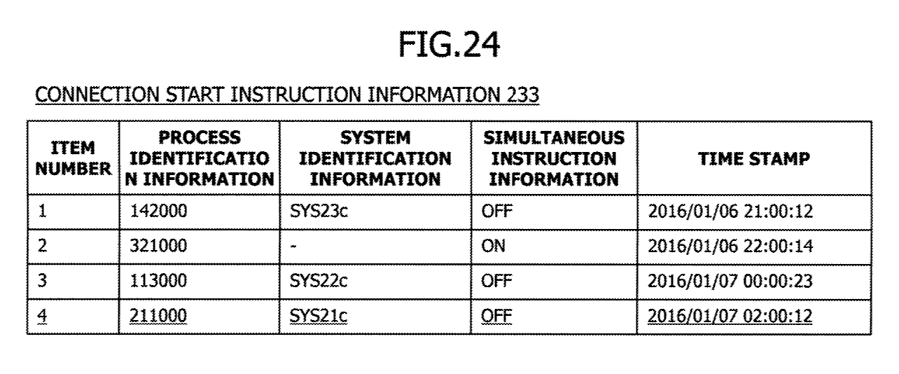

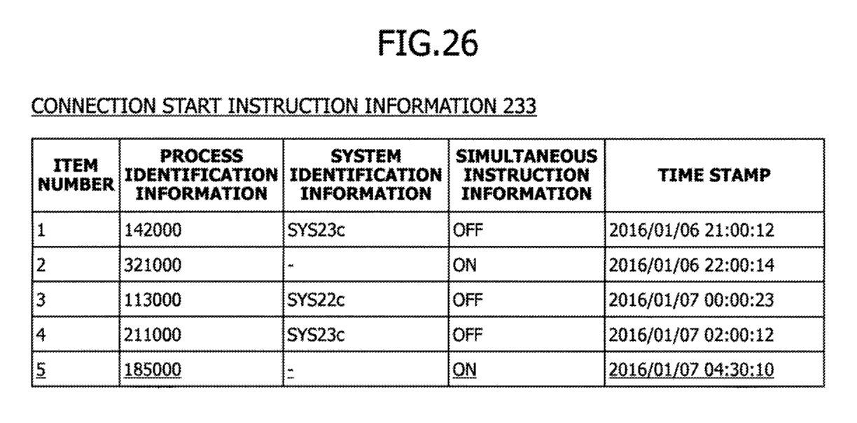

FIGS. 24 and 26 are views for explaining the specific example of the connection start instruction information 233 stored in the information storage area 230. The connection start instruction information 233 illustrated in each of FIG. 24 and FIG. 26 has the same items as those of the connection start instruction explained in FIG. 23. Further, the connection start instruction information 233 illustrated in each of FIG. 24 and FIG. 26 has, as an item, “time stamp” indicative of the date and time when the connection start instruction received from the management device 1 is stored in the information storage area 230.

In the case where the connection start instruction reception unit 211 has received the connection start instruction, the information management unit 216 stores information corresponding to the received connection start instruction in the information storage area 230 as the connection start instruction information 233. Specifically, as illustrated in underlined portions in FIG. 24, the information management unit 216 sets the same information items as “process identification information”, “system identification information”, and “simultaneous instruction information” of the information having “item number” of “1” in the connection start instruction explained in FIG. 23 as “process identification information”, “system identification information”, and “simultaneous instruction information” of information having “item number” of “4”. Further, as illustrated in the underlined portion in FIG. 24, the information management unit 216 sets “2016/01/07 02:00:12” as the date and time when the connection start instruction explained in FIG. 23 is stored in the information storage area 230 as “time stamp” of the information having “item number” of “4”. The description of the other information included in FIG. 24 will be omitted. The description of FIG. 26 will be made later.

[Specific Example of Connection Start Instruction Transmitted by Management Device (2)]

Next, another specific example of the connection start instruction transmitted by the management device 1 will be described. FIG. 25 is a view for explaining another specific example of the connection start instruction transmitted by the management device 1.

In the connection start instruction illustrated in FIG. 25, for information having “item number” of “1”, “185000” is set as “process identification information”, “−” is set as “system identification information”, and “ON” is set as “simultaneous instruction information”.

Note that the connection start instruction illustrated in FIG. 25 is the connection start instruction transmitted to a plurality of business systems, and hence “−” indicating that the same connection start instruction is transmitted to the other business system is set as “system identification information”.

[Specific Example of Connection Start Instruction Information Stored in Information Storage Area (2)]

Next, another specific example of the connection start instruction information 233 stored in the information storage area 230 will be described. FIG. 26 is a view for explaining another specific example of the connection start instruction information 233 stored in the information storage area 230.

In the connection start instruction information 233 illustrated in FIG. 26, as illustrated in underlined portions in FIG. 26, the same information items as “process identification information”, “system identification information”, and “simultaneous instruction information” of the information having “item number” of “1” in the connection start instruction explained in FIG. 25 are set as “process identification information”, “system identification information”, and “simultaneous instruction information” of information having “item number” of “5”. In addition, as illustrated in the underlined portion in FIG. 26, the information management unit 216 sets, for example, “2016/01/07 04:30:10”, which is the date and time when the connection start instruction explained in FIG. 25 is stored in the information storage area 230, as “time stamp” of the information having “item number” of “5”. The description of the other information included in FIG. 26 will be omitted.

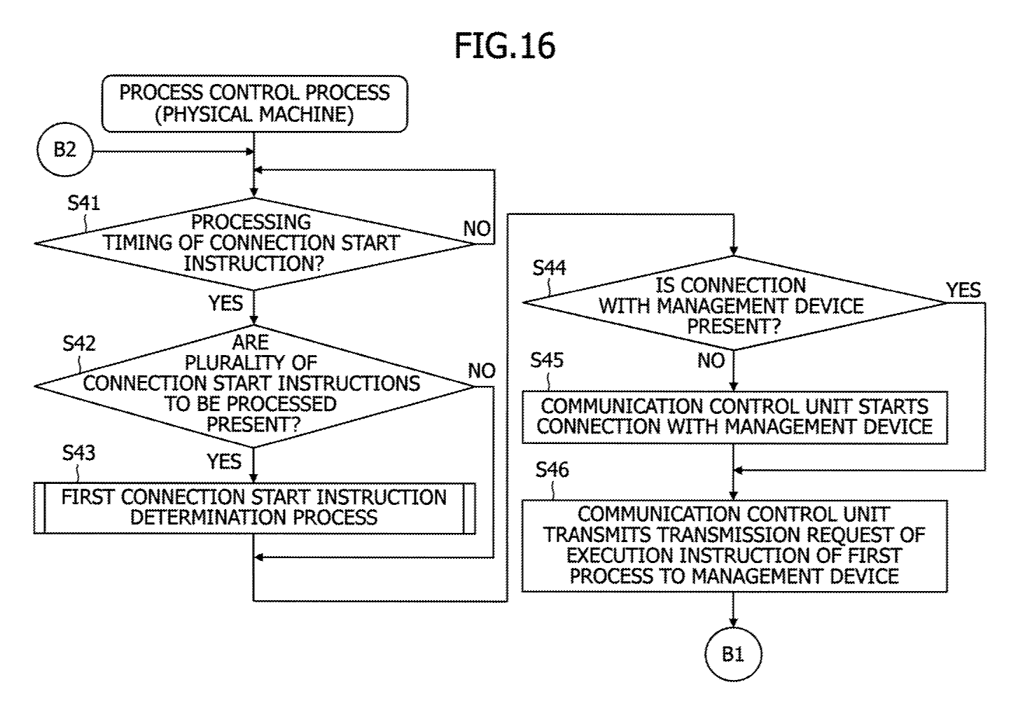

Returning to FIG. 16, similarly to the case explained in FIG. 9, the connection start instruction determination unit 212 stands by until the processing timing of the connection start instruction comes (NO in S41). Subsequently, in the case where the processing timing of the connection start instruction has come (YES in S41), the connection start instruction determination unit 212 determines whether or not a plurality of connection start instructions to be processed are present (S42). Specifically, the connection start instruction determination unit 212 determines whether or not information corresponding to a plurality of connection start instructions transmitted from the management device 1 is included in the connection start instruction information 233 stored in the information storage area 230.

As a result, in the case where the connection start instruction determination unit 212 determines that the plurality of connection start instructions to be processed are present (YES in S42), the connection start instruction determination unit 212 executes a process for determining the first connection start instruction (hereinafter also referred to as a first connection start instruction determination process) (S43). Hereinafter, the first connection start instruction determination process will be described.

[First Connection Start Instruction Determination Process]

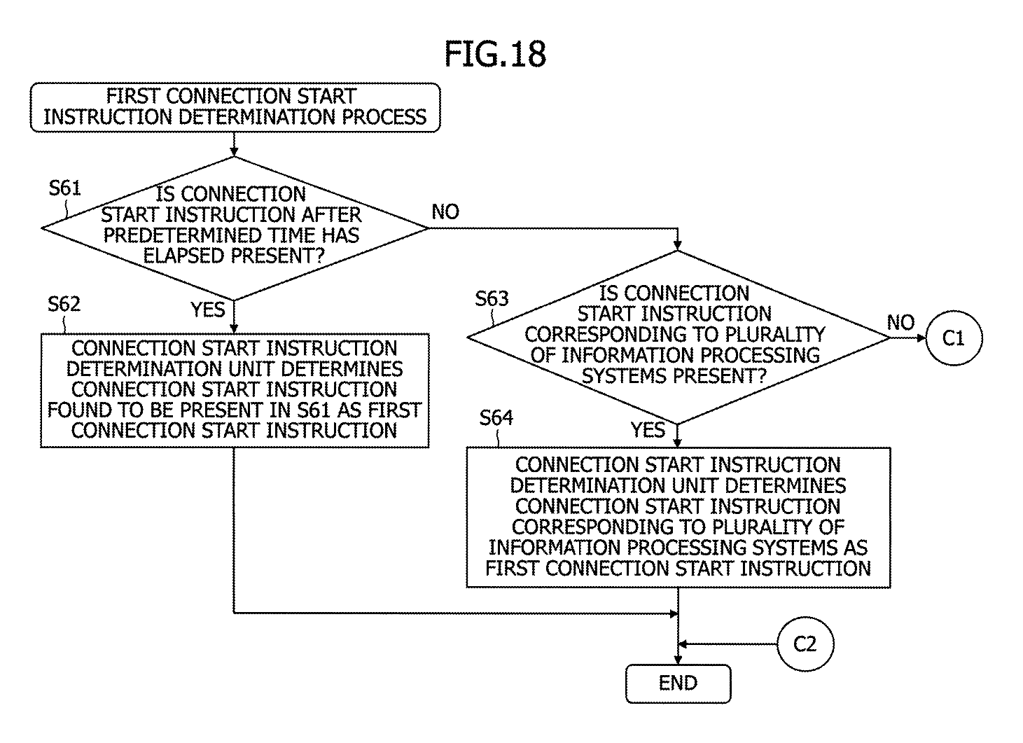

As illustrated in FIG. 18, the connection start instruction determination unit 212 determines whether or not the connection start instruction after the predetermined time (e.g., 1 hour) has elapsed since the reception of the connection start instruction by the connection start instruction reception unit 211 is present (S61). Specifically, the connection start instruction determination unit 212 determines whether or not information corresponding to the connection start instruction after the predetermined time has elapsed since the reception of the connection start instruction by the connection start instruction reception unit 211 is included in the connection start instruction information 233 stored in the information storage area 230.

Subsequently, in the case where the connection start instruction after the predetermined time has elapsed is present (YES in S61), the connection start instruction determination unit 212 determines the connection start instruction found to be present as the first connection start instruction (S62). Note that, in the process in S61, in the case where a plurality of connection start instructions after the predetermined time has elapsed are present, the connection start instruction having the oldest date and time set as “time stamp” of the connection start instruction information 233 may be determined as the first connection start instruction.

In the case where the connection start instruction after the predetermined time has elapsed is not present (NO in S61), the connection start instruction determination unit 212 determines whether or not the connection start instruction corresponding to a plurality of business systems, i.e., information in which “ON” is set as “simultaneous instruction information” is present in the connection start instruction information 233 (S63). Subsequently, in the case where the connection start instruction corresponding to the plurality of business systems is present (YES in S63), the connection start instruction determination unit 212 preferentially determines the connection start instruction corresponding to the plurality of business systems found to be present as the first connection start instruction.

That is, for example, in the case where the management device 1 executes a subsequent process after the reception of the process result information 234 is completed, the physical machine 2 needs to transmit the process result information 234 to the management device 1 as quickly as possible. Herein, the first process corresponding to the connection start instruction information 233 in which “ON” is set as “simultaneous instruction information” is executed in a plurality of business systems. Accordingly, a possibility that the length of time before the process result information 234 of all of the first processes corresponding to the connection start instruction information 233 in which “ON” is set as “simultaneous instruction information” is transmitted to the management device 1 is longer than the length of time in the case of the connection start instruction information 233 in which “OFF” is set as “simultaneous instruction information” is high. Accordingly, the connection start instruction determination unit 212 determines the connection start instruction information 233 in which “ON” is set as “simultaneous instruction information” as the first connection start instruction in preference to the connection start instruction information 233 in which “OFF” is set as “simultaneous instruction information”. With this, it becomes possible for the connection start instruction determination unit 212 to reduce waiting time for execution of the subsequent process in the management device 1.

Note that, in the process in S63, in the case where a plurality of connection start instructions corresponding to the plurality of business systems are present, the connection start instruction having the oldest date and time set as the “time stamp” of the connection start instruction information 233 may be determined as the first connection start instruction.

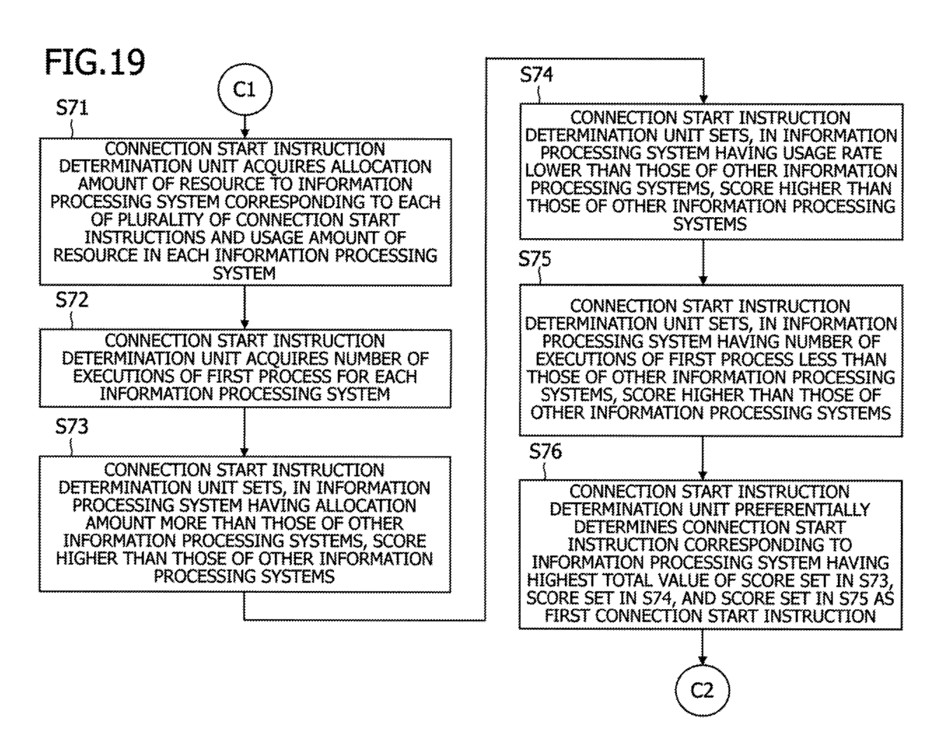

On the other hand, in the case where the connection start instruction information 233 corresponding to the plurality of business systems is not present (NO in S63), as illustrated in FIG. 19, the connection start instruction determination unit 212 acquires the allocation amount information 231 of the resource from the information storage area 230 (S71). Specifically, the connection start instruction determination unit 212 acquires the allocation amount information 231 of the resource to the business systems corresponding to each connection start instruction from the information storage area 230. In this case, the connection start instruction determination unit 212 acquires the usage amount information 232 of the resource in each business system (S71). Further, the connection start instruction determination unit 212 acquires the current number of executions of the process (the first process) resulting from the connection start instruction for each business system (S72).

Thereafter, for example, the connection start instruction determination unit 212 sets, in the business system having the allocation amount information 231 more than those of the other business systems, a score higher than those of the other business systems (S73). That is, the connection start instruction determination unit 212 sets a higher score in the business system having a higher processing ability.

In addition, for example, the connection start instruction determination unit 212 sets, in the business system having the usage amount information 232 less than those of the other business systems, a score higher than those of the other business systems (S74). Further, for example, the connection start instruction determination unit 212 sets, in the business system having the number of executions of the first process less than those of the other business systems, a score higher than those of the other business systems (S75). That is, the connection start instruction determination unit 212 sets a high score in the business system having a sufficient processing ability.

Subsequently, the connection start instruction determination unit 212 preferentially determines, as the first connection start instruction, the connection start instruction corresponding to the business system having the highest total value of the score set in the process in S73, the score set in the process in S74, and the score set in the process in S75 (S76). With this, it becomes possible for the connection start instruction determination unit 212 to execute the first process while preventing an increase in the processing burden of each business system.

[Specific Examples of Processes from S73 to S76]

Next, specific examples of the processes from S71 to S76 will be described. Hereinafter, the description will be made on the assumption that a CPU factor is “1.2”, a memory factor is “1”, and an I/O factor is “0.4”.

The connection start instruction determination unit 212 calculates the processing ability of each business system that is used when the score is determined in the process in S73 according to, e.g., the following expression (1).

processing ability of business system=CPU allocation rate to business system*CPU factor+memory allocation rate to business system*memory factor+I/O resource allocation rate to business system*I/O factor (1)

Specifically, in the allocation amount information 133 (the allocation amount information 231) illustrated in FIG. 22, “CPU information”, “memory information”, and “I/O information” of the business system having “SYS21a” as “system identification information” are “2.4 (Ghz)”, “20 (GB)”, and “15(%)” respectively. Accordingly, in the case where the allocatable amount of the CPU of the physical machine 2a is “16 (Ghz)”, the CPU allocation rate to the business system SYS21a is “0.15” obtained by dividing “2.4 (Ghz)” by “16 (Ghz)”. In addition, in the case where the allocatable amount of the memory of the physical machine 2a is “30 (GB)”, the memory allocation rate to the business system SYS21a is “0.8” obtained by dividing “20 (GB)” by “25 (GB)”. Further, the I/O resource allocation rate to the business system SYS21a is “0.15”.

Consequently, in this case, the processing ability of the business system SYS21a is “1.04” as a value obtained by adding up a value obtained by multiplying “0.15” as the CPU allocation rate by “1.2” as the CPU factor, a value obtained by multiplying “0.8” as the memory allocation rate by “1” as the memory factor, and a value obtained by multiplying “0.15” as the I/O resource allocation rate by “0.4” as the I/O factor.

Subsequently, after the connection start instruction determination unit 212 calculates the processing ability of each business system, the connection start instruction determination unit 212 sets, in the business system having the calculated processing ability higher than those of the other business systems, the score higher than those of the other business systems. Specifically, for example, the connection start instruction determination unit 212 sets, as the scores, “5”, “4”, “3”, “2”, “1”, and “0” in the business systems SYS21a, SYS31b, SYS32b, SYS21c, SYS22c, and SYS23c explained in FIG. 4 and the like respectively in descending order of the value indicated by the calculated processing ability.

In addition, the connection start instruction determination unit 212 calculates load information of each business system that is used when the score is determined in the process in S74 according to, e.g., the following expression (2).

load information of business system=usage rate to CPU allocated to business system*CPU factor+usage rate to memory allocated to business system*memory factor+usage rate to I/O resource allocated to business system*I/O factor (2)

Specifically, in the allocation amount information 133 (the allocation amount information 231) illustrated in FIG. 22, “CPU information” of the business system having “SYS21a” as “system identification information” is “2.4 (Ghz)”, “memory information” thereof is “20 (GB)”, and “I/O information” thereof is “15(%)”. Accordingly, in the case where the usage amount of the CPU of the physical machine 2a is “1.2 (Ghz)”, the usage rate to the CPU allocated to the business system SYS21a is “0.5” obtained by dividing “1.2 (Ghz)” by “2.4 (Ghz)”. In addition, in the case where the usage amount of the memory of the physical machine 2a is “15 (GB)”, the usage rate to the memory allocated to the business system SYS21a is “0.75” obtained by dividing “15 (GB)” by “20 (GB)”. Further, in the case where the usage amount of the I/O resource of the business system SYS21a is “6(%)” to the allocatable amount of the I/O resource of the physical machine 2a, the usage rate to the I/O resource allocated to the business system SYS21a is “0.4” obtained by dividing “6(%)” by “15(%)”.

Consequently, in this case, the load information of the business system SYS21a is “1.51” as a value obtained by adding up a value obtained by multiplying “0.5” as the CPU usage rate by “1.2” as the CPU factor, a value obtained by multiplying “0.75” as the memory usage rate by “1” as the memory factor, and a value obtained by multiplying “0.4” as the I/O resource usage rate by “0.4” as the I/O factor.

Subsequently, after the connection start instruction determination unit 212 calculates the load information of each business system, the connection start instruction determination unit 212 sets, in the business system having the calculated load information less than those of the other business systems, the score higher than those of the other business systems. Specifically, for example, the connection start instruction determination unit 212 sets, as the scores, “5”, “4”, “3”, “2”, “1”, and “0” in the business systems SYS21a, SYS31b, SYS32b, SYS21c, SYS22c, and SYS23c respectively in ascending order of the value indicated by the calculated load information.

Further, in the process in S75, the connection start instruction determination unit 212 sets the scores of the individual business systems in ascending order of the current number of executions of the first process. Specifically, for example, the connection start instruction determination unit 212 sets, as the scores, “5”, “4”, “3”, “2”, “1”, and “0” in the business systems SYS21a, SYS31b, SYS32b, SYS21c, SYS22c, and SYS23c respectively in ascending order of the current number of executions of the first process.

Thereafter, in the process in S76, the connection start instruction determination unit 212 calculates the total value of the score set in the process in S73, the score set in the process in S74, and the score set in the process in S75 for each business system. Specifically, for example, in the case where the total value of the score calculated for the business system SYS21c is highest, the connection start instruction determination unit 212 determines the connection start instruction corresponding to the business system SYS21c as the first connection start instruction.

Note that, in the case where a plurality of connection start instructions corresponding to the business system having the highest total value of the score in the process in S76 are present, the connection start instruction determination unit 212 may determine the connection start instruction having the oldest date and time set as “time stamp” of the connection start instruction information 233 as the first connection start instruction.

Returning to FIG. 16, in the case where the connection with the management device 1 is not present (NO in S44), the communication control unit 213 performs the setting of the connection with the management device 1 (S45). On the other hand, in the case where the connection with the management device 1 is present (YES in S44), the communication control unit 213 does not perform the process in S45. Subsequently, the communication control unit 213 transmits the transmission request of the execution instruction of the process (the first process) resulting from the connection start instruction to the management device 1 (S46).

Note that, as the result of the setting of the connection performed in the process in S45, in the case where the number of the connection destination devices 2 connected with the management device 1 exceeds the predetermined number, the communication control unit 113 of the management device 1 may execute the same process as the process explained in S28, and disconnect the connection with which the transmission and reception of the information are unlikely to be performed in the future.

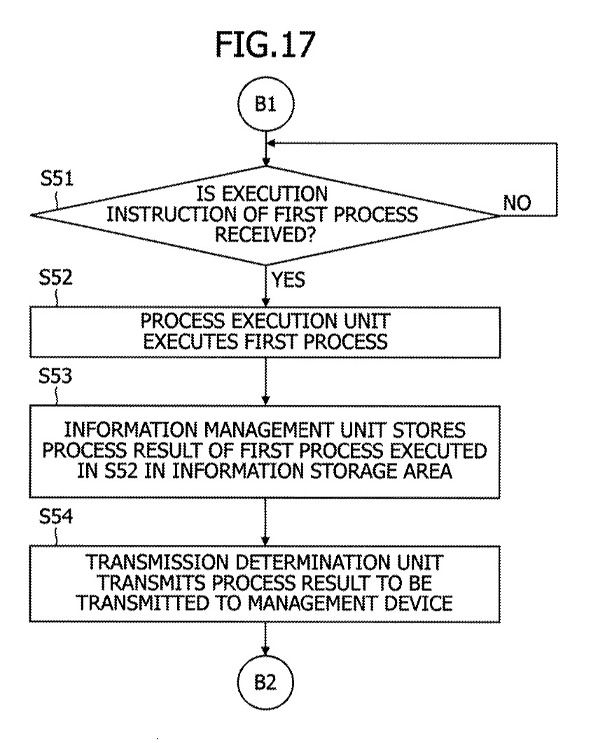

Thereafter, as illustrated in FIG. 17, the communication control unit 213 stands by until the communication control unit 213 receives the execution instruction of the first process from the management device 1 (NO in S51). Subsequently, in the case where the communication control unit 213 has received the execution instruction of the first process (YES in S51), the process execution unit 214 executes the first process (S52). Hereinafter, a specific example of the execution instruction of the first process will be described.

[Specific Example of Execution Instruction of First Process]

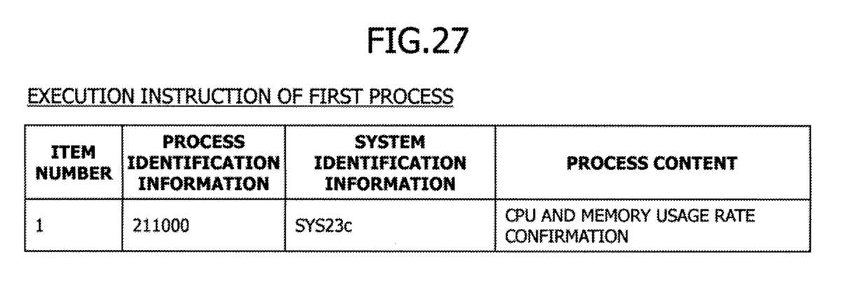

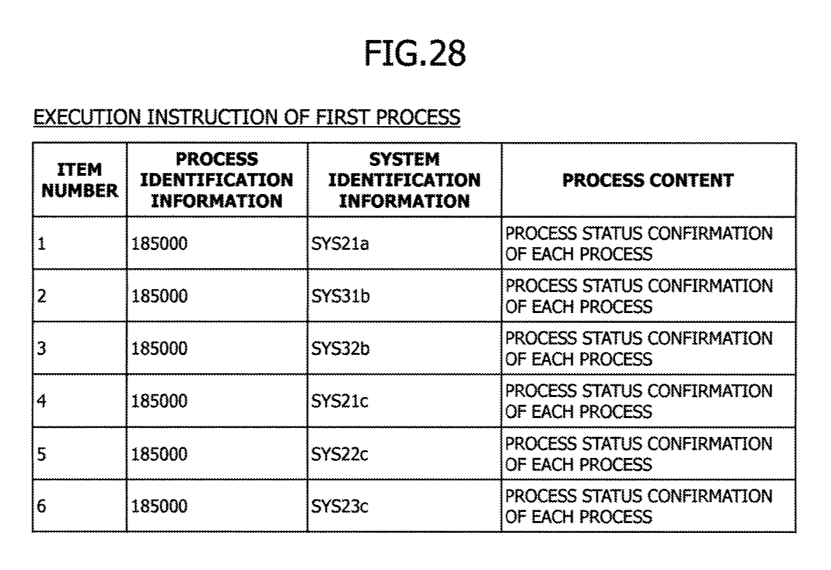

FIGS. 27 and 28 are views for explaining the specific example of the execution instruction of the first process. Note that the execution instruction illustrated in FIG. 27 is the execution instruction corresponding to information having “item number” of “4” in the connection start instruction information 233 explained in FIG. 26. The execution instruction illustrated in FIG. 28 is the execution instruction corresponding to information having “item number” of “5” in the connection start instruction information 233 illustrated in FIG. 26.

Each of the execution instructions illustrated in FIGS. 27 and 28 has, as items, “item number” for identifying each information included in the execution instruction, “process identification information” for identifying the operation process, and “system identification information” for identifying the business system that is caused to execute the process (the first process) for executing the operation process. In addition, the execution instruction of the first process illustrated in each of FIGS. 27 and 28 has, as an item, “process content” indicative of the content of the first process.

Specifically, in the execution instruction illustrated in FIG. 27, for information having “item number” of “1”, “211000” is set as “process identification information”, and “SYS23c” is set as “system identification information”. In addition, in the execution instruction illustrated in FIG. 27, for the information having “item number” of “1”, “CPU and memory usage rate confirmation” is set as “process content”.

That is, “OFF” is set as “simultaneous instruction information” of the information having “item number” of “4” in the connection start instruction information 233 illustrated in FIG. 26. Accordingly, the execution instruction illustrated in FIG. 27 includes the execution instruction to one business system (SYS23c). Consequently, in this case, only the process execution unit 214 corresponding to the business system SYS23c executes the first process.

In the execution instruction illustrated in FIG. 28, for information having “item number” of “1”, “185000” is set as “process identification information”, and “SYS21a” is set as “system identification information”. In addition, in the execution instruction illustrated in FIG. 28, for the information having “item number” of “1”, “process status confirmation of each process” is set as “process content”. Further, for information having “item number” of “2”, “185000” is set as “process identification information”, and “SYS31b” is set as “system identification information”. Furthermore, in the execution instruction illustrated in FIG. 28, for the information having “item number” of “2”, “process status confirmation of each process” is set as “process content”.

That is, “ON” is set as “simultaneous instruction information” of the information having “item number” of “5” in the connection start instruction information 233 illustrated in FIG. 26. Accordingly, the execution instruction illustrated in FIG. 28 includes the execution instruction to a plurality of business systems (SYS21a, SYS31b, SYS32b, SYS21c, SYS22c, and SYS23c). Consequently, in this case, each of the process execution units 214 corresponding to the individual business systems executes the first process.

Note that, in the case where the execution instruction of the first process received from the management device 1 includes the execution instruction to a plurality of business systems configured in the same physical machine 2, the physical machine 2 may calculate a margin value of each business system according to, e.g., the following expression (3). Subsequently, for example, the physical machine 2 may sequentially cause the process execution units 214 to execute the first process in ascending order of the calculated margin value of the business system to which the process execution unit 214 corresponds.

margin value of business system=unused amount of CPU allocated to business system*CPU factor+unused amount of memory allocated to business system*memory factor+unused amount of I/O resource allocated to business system*I/O factor (3)

Specifically, in the allocation amount information 133 illustrated in FIG. 22, “CPU information” of the business system having “SYS23a” as “system identification information” is “2.4 (Ghz)”, and “memory information” thereof is “20 (GB)”. Accordingly, in the case where the usage amount of the CPU of the business system SYS21a is “1.6 (Ghz)”, the unused amount of the CPU allocated to the business system SYS21a is “0.8 (Ghz)” obtained by subtracting “1.6 (Ghz)” from “2.4 (Ghz)”. In addition, in the case where the usage amount of the memory of the business system SYS21a is “18 (GB)”, the unused amount of the memory allocated to the business system SYS21a is “2 (GB)” obtained by subtracting “18 (GB)” from “20 (GB)”. Further, in the case where the allocation amount of the I/O resource to the business system SYS21a is “12” and the usage amount of the I/O resource of the business system SYS21a is “8”, the unused amount of the I/O resource allocated to the business system SYS21a is “4” obtained by subtracting “8” from “12”.

Consequently, in this case, the margin value of the business system SYS21a is “4.56” as a value obtained by adding up a value obtained by multiplying “0.8 (Ghz)” as the unused amount of the CPU by “1.2” as the CPU factor, a value obtained by multiplying “2 (GB)” as the unused amount of the memory by “1” as the memory factor, and a value obtained by multiplying “4” as the unused amount of the I/O resource by “0.4” as the I/O factor.

In the case where the business system having the smallest calculated margin value is the business system SYS31b, the physical machine 2 may sequentially cause the business systems to execute the first process from the business system SYS31b.

With this, it becomes possible for the physical machine 2 to preferentially cause the business system having a high processing load (the business system that may need a long time to perform the process due to an insufficient resource) to execute the first process. Accordingly, it becomes possible for the physical machine 2 to reduce the time needed for the execution of all of the first processes to be executed.

Returning to FIG. 17, the information management unit 216 stores the process result of the first process executed by each process execution unit 214 in the process in S52 in the information storage area 230 as the process result information 234 (S53). Hereinafter, a specific example of the process result information 234 will be described.

[Specific Example of Process Result Information]

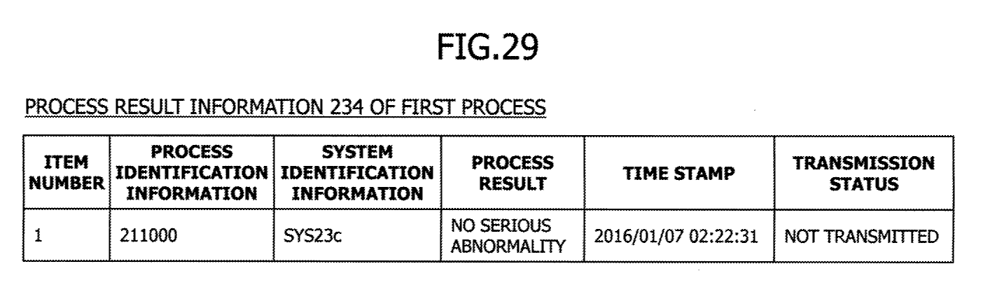

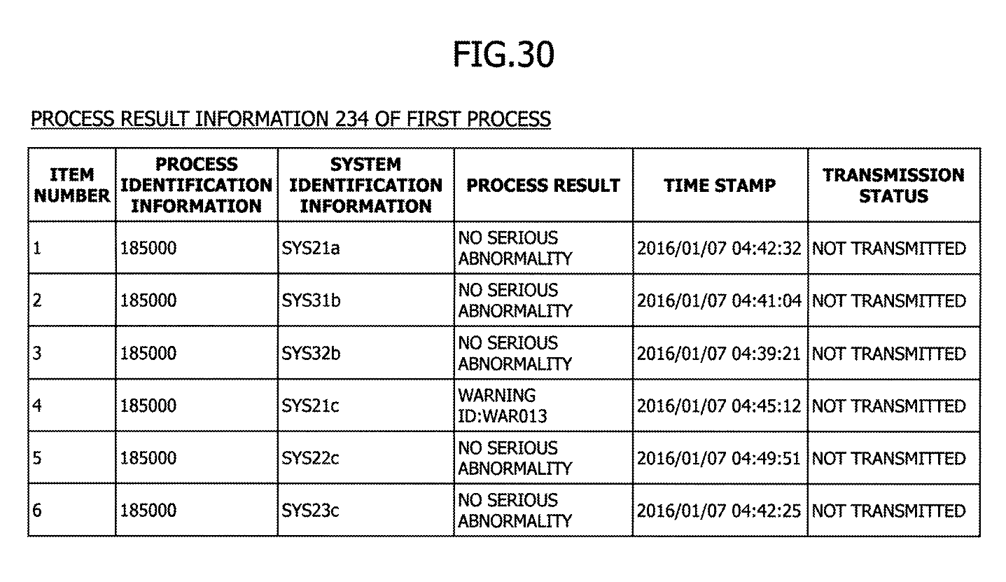

FIGS. 29 and 30 are views for explaining the specific example of the process result information 234. Note that the process result information 234 illustrated in FIG. 29 is the process result information 234 corresponding to the execution instruction of the first process explained in FIG. 27. The process result information 234 illustrated in FIG. 30 is the process result information 234 corresponding to the execution instruction of the first process explained in FIG. 28.

The process result information 234 illustrated in each of FIGS. 29 and 30 has, as items, “item number” for identifying each information included in the process result information 234, “process identification information” for identifying the operation process, and “system identification information” for identifying the business system that has executed the first process. In addition, the process result information 234 illustrated in each of FIGS. 29 and 30 has, as items, “process result” indicative of the process result of the first process, “time stamp” indicative of the date and time of execution of the first process, and “transmission status” indicative of whether or not information is information already transmitted to the management device 1. As “transmission status”, “transmitted” indicating that the information is the information already transmitted to the management device 1, or “not transmitted” indicating that the information is the information that is not transmitted to the management device 1 is set.

Specifically, in the process result information 234 illustrated in FIG. 29, for information having “item number” of “1”, “211000” is set as “process identification information”, and “SYS23c” is set as “system identification information”. In addition, in the process result information 234 illustrated in FIG. 29, for the information having “item number” of “1”, “no serious abnormality” is set as “process result”, “2016/01/07 02:22:31” is set as “time stamp”, and “not transmitted” is set as “transmission status”.

That is, the process result information 234 illustrated in FIG. 29 indicates that, as the result of the execution of the first process in the business system SYS23c, no serious abnormality has been present.

In addition, in the process result information 234 illustrated in FIG. 30, for information having “item number” of “1”, “185000” is set as “process identification information”, and “SYS21a” is set as “system identification information”. In addition, in the process result information 234 illustrated in FIG. 30, for the information having “item number” of “1”, “no serious abnormality” is set as “process result”, “2016/01/07 04:42:32” is set as “time stamp”, and “not transmitted” is set as “transmission status”. Further, for information having “item number” of “4”, “185000” is set as “process identification information”, and “SYS21c” is set as “system identification information”. Furthermore, in the process result information 234 illustrated in FIG. 30, for the information having “item number” of “4”, “warning ID:WAR013” is set as “process result”, “2016/01/07 04:45:12” is set as “time stamp”, and “not transmitted” is set as “transmission status”.

That is, the process result information 234 illustrated in FIG. 30 indicates that, as the result of the execution of the first process in the business system SYS21c, a warning has been generated. Accordingly, as will be described later, the communication control unit 213 transmits the process result information 234 to the management device 1, whereby it becomes possible for the cloud service provider to recognize a necessity to examine the operational status of the business system SYS21c. The description of the other information included in FIG. 30 will be omitted.

Returning to FIG. 17, the transmission determination unit 215 transmits, from among the process result information 234 stored in the information storage area 230, the information to be transmitted to the management device 1 (S54). Specifically, the transmission determination unit 215 determines the information to be transmitted by determining the information in which “not transmitted” is set as “transmission status” from among the process result information 234 stored in the information storage area 230. Subsequently, the transmission determination unit 215 changes the information set as “transmission status” corresponding to the information transmitted to the management device 1, to “transmitted” by updating.

Note that, in the case where sets of information to be transmitted are present among the process result information 234 stored in the information storage area 230, the transmission determination unit 215 transmits the information having the oldest data and time set as “time stamp” of the process result information 234 to the management device 1.

In addition, when the connection start instruction determination unit 212 executes the process in S43 (the first connection start instruction determination process), in the case where the process result information 234 to be transmitted is present, the connection start instruction determination unit 212 may suspend the execution of the process in S43 until the information to be transmitted is transmitted to the management device 1. With this, it becomes possible for the connection start instruction determination unit 212 to speedily transmit the process result information 234 to the management device 1. Accordingly, in the case where the management device 1 needs to execute the subsequent process after the reception of the process result information 234 is completed, it becomes possible to advance the timing of execution of the subsequent process.

Thus, the physical machine 2 in the present embodiment receives the connection start instruction from the management device 1 that makes the process request to the physical machine 2. Subsequently, in the case where a plurality of connection start instructions to be processed are present, the physical machine 2 acquires the allocation amount information 231 of the resource to the business system corresponding to each of the plurality of connection start instructions. In addition, in this case, the physical machine 2 acquires the usage amount information 232 of the resource in each information processing system. Thereafter, the physical machine 2 determines the first connection start instruction that is preferentially processed from among the plurality of connection start instructions based on the allocation amount information 231 and the usage amount information 232.

With this, the physical machine 2 does not need to set the connection between the management device 1 and each business system, and it becomes possible to reduce the number of the connections set between each physical machine 2 and the management device 1. Accordingly, it becomes possible for the cloud service provider to manage the physical machines 2 that constitute the large-scale public cloud environment while preventing the increase in the number of the management devices 1 to be provided.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a process control program that causes a computer to execute a process comprising:
receiving a connection start instruction from a process request device that transmits a process request to the computer; and
determining, in a case where a plurality of connection start instructions to be processed are present, a first connection start instruction that is preferentially processed from among the plurality of connection start instructions based on an allocation amount of a resource to each of a plurality of information processing systems corresponding to each of the plurality of connection start instructions and a usage amount of the resource in each of the plurality of information processing systems.

2. The non-transitory computer-readable storage medium storing therein a process control program according to claim 1, wherein
the determining includes determining the connection start instruction corresponding to an information processing system having the allocation amount more than the allocation amount of another information processing system as the first connection start instruction in preference to the connection start instruction corresponding to the other information processing system.

3. The non-transitory computer-readable storage medium storing therein a process control program according to claim 1, wherein
the determining includes:
calculating a usage rate of the resource for each information processing system by dividing the usage amount by the allocation amount, and
determining the connection start instruction corresponding to an information processing system having the calculated usage rate lower than the usage rate of another information processing system as the first connection start instruction in preference to the connection start instruction corresponding to the other information processing system.

4. The non-transitory computer-readable storage medium storing therein a process control program according to claim 1, wherein
the connection start instruction includes information indicating whether or not a plurality of information processing systems that are corresponding to the connection start instruction are present, and
the determining includes:
determining the connection start instruction that includes information indicating that the plurality of information processing systems that are corresponding to the connection start instruction are present as the first connection start instruction in preference to the connection start instruction that includes information indicating that the plurality of information processing systems that are corresponding to the connection start instruction are not present.

5. The non-transitory computer-readable storage medium storing therein a process control program according to claim 1, wherein
transmission of the connection start instruction is performed according to a user datagram protocol (UDP).

6. The non-transitory computer-readable storage medium storing therein a process control program according to claim 5, the program that causes the computer to execute the process further comprising:
starting a connection with the process request device and transmitting a transmission request of an execution instruction of a first process resulting from the first connection start instruction to the process request device after the determining;
causing the information processing system corresponding to the first connection start instruction to execute the first process according to reception of the execution instruction of the first process; and
transmitting a process result of the first process to the process request device.

7. The non-transitory computer-readable storage medium storing therein a process control program according to claim 6, wherein
transmission of the transmission request of the execution instruction of the first process, transmission of the execution instruction of the first process, and transmission of the process result of the first process are performed according to a transmission control protocol (TCP).

8. The non-transitory computer-readable storage medium storing therein a process control program according to claim 6, wherein
the determining includes:
determining the connection start instruction corresponding to an information processing system having the number of executions of the first process less than the number of executions of the first process of another information processing system as the first connection start instruction in preference to the connection start instruction corresponding to the other information processing system.

9. The non-transitory computer-readable storage medium storing therein a process control program according to claim 6, the program that causes the computer to execute the process further comprising:
suspending the determining, in a case where the process result of the first process to be transmitted is present, until transmission of the process result of the first process is performed.

10. A process control device comprising:
a processor configured to:
receive a connection start instruction from a process request device that transmits a process request; and
determine, in a case where a plurality of connection start instructions to be processed are present, a first connection start instruction that is preferentially processed from among the plurality of connection start instructions based on an allocation amount of a resource to each of a plurality of information processing systems corresponding to each of the plurality of connection start instructions and a usage amount of the resource in each of the plurality of information processing systems.

11. A process control method comprising:
transmitting, by a process request device that transmits a process request to a process device, a connection start instruction to the process device;
receiving, by the process device, the connection start instruction transmitted from the process request device; and
determining, by the process device, in a case where a plurality of connection start instructions to be processed are present, a first connection start instruction that is preferentially processed from among the plurality of connection start instructions based on an allocation amount of a resource to each of a plurality of information processing systems corresponding to each of the plurality of connection start instructions and a usage amount of the resource in each of the plurality of information processing systems.

12. The process control method according to claim 11, further comprising:
after the determining, starting, by the process device, a connection with the process request device and transmitting, by the process device, a transmission request of an execution instruction of a first process resulting from the first connection start instruction to the process request device;
transmitting, by the process request device, the execution instruction of the first process to the process device according to reception of the transmission request of the execution instruction of the first process;
causing, by the process device, the information processing system corresponding to the first connection start instruction to execute the first process according to reception of the execution instruction of the first process; and
transmitting, by the process device, a process result of the first process to the process request device.

13. The process control method according to claim 12, further comprising:
after the transmitting a process result of the first process, determining, by the process request device, in a case where the number of connection destination devices connected with the process request device exceeds a predetermined number, the information processing system for which there is another information processing system that has the allocation amount identical to the allocation amount of the information processing system and in which a process that needs transmission and reception of information to and from the process request device is being executed; and
disconnecting, by the process request device, the connection with the connection destination device other than the connection destination device in which the determined information processing system operates preferentially until the number of the connection destination devices becomes equal to or less than the predetermined number.

14. The process control method according to claim 11, further comprising:
retransmitting, by the process request device, in a case where the process device to which the connection start instruction is transmitted from the process request device and from which the process request device is not able to receive a transmission request of an execution instruction of a first process is present, the transmitted connection start instruction to the process device from which the process request device is not able to receive the transmission request of the execution instruction of the first process.
